(19) United States
(12) Patent Application Publication
(10) Pub. No.: US 2025/0207867 A1
(43) Pub. Date: Jun. 26, 2025

(54) THERMAL ENERGY STORAGE SYSTEMS

(71) Applicant: PHASESTOR LLC, Asheboro, NC (US)

(72) Inventors: Rami M. Saeed, Greensboro, NC (US); Reyad I. Sawafta, Greensboro, NC (US)

(21) Appl. No.: 19/007,439

(22) Filed: Dec. 31, 2024

Related U.S. Application Data
(63) Continuation of application No. 17/438,576, filed on Sep. 13, 2021.
(60) Provisional application No. 62/819,257, filed on Mar. 15, 2019.

(51) Int. Cl. F28D 20/02; F28D 9/00; F28F 3/14

(52) U.S. Cl. CPC F28D 20/021; F28D 9/0031; F28F 3/14; F28F 2275/06

(57) ABSTRACT

A thermal energy storage system includes a container, a heat exchanger disposed within the container, and a phase change material (PCM) disposed within the container. The heat exchanger includes an inlet pipe, an outlet pipe; and a plurality of plates in fluid communication with the inlet pipe and the outlet pipe. The inlet pipe, outlet pipe, and plates are arranged and connected such that a fluid flowing from the inlet pipe and to the outlet pipe flows through the plates in between the inlet pipe and the outlet pipe. The PCM disposed within the container is also in thermal contact with the plates for heat exchange between the fluid and the PCM.

### CROSS REFERENCE TO RELATED APPLICATIONS

This application claims priority pursuant to 35 U.S.C. § 119 to U.S. Provisional Patent Application Ser. No. 62/819,257, filed on Mar. 15, 2019, which is hereby incorporated by reference in its entirety.

### FIELD

The present disclosure relates to thermal energy storage and management systems including a phase change material (PCM) or latent heat storage material, and to methods of storing and releasing thermal energy using such systems.

### BACKGROUND

The production of electricity is generally more expensive during peak demand hours than at low demand hours. Therefore, various thermal energy storage systems have been developed which permit the storage of thermal energy for later use, such as during peak demand hours. Such deferred use of stored energy can reduce strain on the power grid and/or reduce the average cost of energy per kilowatt-hour during peak load periods. However, some previous thermal energy storage systems suffer from one or more disadvantages, such as short thermal energy storage periods, low efficiency, low versatility, and difficulty of installation. Improved thermal energy storage systems are therefore desired.

### SUMMARY

In one aspect, thermal energy storage and management systems are described herein. Such systems, in some cases, can provide one or more advantages compared to some existing systems. In some embodiments, for example, a system described herein can provide more versatile thermal energy storage and release than some existing systems. A system described herein, in some cases, also provides multifunctional or multi-modal storage and release of thermal energy. Additionally, a system described herein, in some instances, is easier to install, use, and maintain, as compared to some other systems. Moreover, systems described herein can be used for a variety of end-uses or applications, including but not limited to thermal energy storage, release, and management for industrial, commercial, and/or residential buildings, such as may be desired for so-called load shifting of energy use of a heating, ventilating, and air conditioning (HVAC) system of a building, or for load shifting of other energy used by the building. In this manner, as described above, the cost of energy obtained from a power grid or from an alternative source of energy (such as a solar panel) can be reduced. Systems described herein may also be used for the management and/or “recycling” of waste heat, or for the management of undesired or potentially hazardous thermal energy. For example, in some cases, a system described herein can be used to maintain or otherwise manage the temperature of a nuclear reactor cooling pool (such as for fuel rods), including during a general power outage or other loss of power. A system described herein may also be used to capture, store, and subsequently discharge on demand the thermal energy of a source of “waste heat,” such as steam. Thermal energy storage and management systems described herein may be used advantageously for other purposes also, as described further herein.

In some embodiments, a thermal energy storage system described herein comprises a container, a heat exchanger disposed within the container, and a phase change material (PCM) disposed within the container. The heat exchanger comprises an inlet pipe (or inlet “header”), an outlet pipe (or outlet “header”), and a number n of plates in fluid communication with the inlet pipe and the outlet pipe, wherein n is at least 2, such that a plurality of plates is used. The inlet pipe, outlet pipe, and plates are arranged and connected such that a fluid flowing from the inlet pipe and to the outlet pipe flows through the plates (or at least a portion of the plates or some of the plates) in between the inlet pipe and the outlet pipe. For instance, in such an arrangement, a fluid flowing into the inlet pipe and out of the outlet pipe flows through at least a portion of the plates after flowing into the inlet pipe but before flowing out of the outlet pipe. Moreover, in thermal energy storage systems described herein, the PCM disposed within the container is also in thermal contact with the plates of the heat exchanger. Additionally, it is to be understood that fluid generally enters the heat exchanger through an end of the inlet pipe denoted herein as the “proximal” end. Moreover, as described further herein, fluid generally exits the heat exchanger through a “distal” end of the outlet pipe or (in some cases) through a distal end of the inlet pipe. Additional features of various components of thermal energy storage systems are described further in the detailed description which follows.

As described further herein, it is also to be understood that various exterior systems can be connected to a thermal energy storage system of the present disclosure, such that fluid communication is provided between the plates of the thermal energy storage system and the exterior system. For instance, in some cases, an HVAC chiller or source of waste heat (external to the thermal energy storage system itself) is attached to or associated with the thermal energy storage system.

In another aspect, methods of storing and releasing thermal energy are described herein. In some cases, such a method comprises attaching a thermal energy storage or management system described herein to an external source of an external fluid. In some implementations, the external fluid is liquid water. Additionally, the external source of the external fluid can comprise an HVAC chiller or a source of waste heat. Moreover, methods described herein, in some instances, further comprise forcing a first portion of the external fluid through the heat exchanger of the thermal energy system. That is, the external fluid enters the heat exchanger of the system through a proximal end and exits the heat exchanger through a distal end, having passed through the plates of the heat exchanger. Further, in some embodiments, the first portion of the external fluid enters the heat exchanger at a first or initial temperature (T1) and exits the heat exchanger at a second or exit temperature (T2), where T1 and T2 are different. For example, T1 can be higher or lower than T2. In addition, the first portion of the external fluid can participate in thermal energy transfer or heat exchange with the PCM disposed in the container of the relevant thermal energy storage and/or management system. In some embodiments, for example, the first portion of the external fluid transfers thermal energy or heat to the PCM, thereby lowering the temperature of the first portion of the external fluid. The PCM, in turn, can store at least a portion of the transferred thermal energy as latent heat (e.g., by using the received thermal energy to undergo a phase transition, such as a transition from a solid state to a liquid state). A method described herein, in some implementations, further comprises forcing a second portion of the external fluid through the heat exchanger of the thermal energy system and transferring at least a portion of the stored latent heat from the PCM to the second portion of the external fluid, thereby increasing the temperature of the second portion of the external fluid. Such subsequent “discharging” of the PCM can occur at a subsequent time period, which may be hours or even days later.

In this manner, as described further herein, a thermal energy storage system can store thermal energy during a first time interval and release it during a second time interval. For example, the system can store thermal energy when the PCM of the system is exposed to a relatively warm external fluid, where the relative warmth of the external fluid is based on the external fluid having a temperature that is greater than the relevant phase transition temperature of the PCM and greater than the temperature of the PCM. The system can release the stored thermal energy when the PCM of the system is later exposed to a relatively cool external fluid.

It is also possible for the storing-and-releasing cycle described above to be carried out in the opposite sequence—releasing of thermal energy (i.e., heating of the external fluid) followed by storing of thermal energy (i.e., cooling of the external fluid).

These and other implementations are described in more detail in the detailed description which follows.

### BRIEF DESCRIPTION OF THE DRAWINGS

FIG. 1 illustrates an exploded perspective view of a thermal energy storage system according to one embodiment described herein.

FIG. 2 illustrates a sectional side view of the thermal energy storage system of FIG. 1

FIG. 3 illustrates an adjacent side view of the thermal energy storage system of FIG. 2

FIG. 4 illustrates a top plan view of the thermal energy storage system of FIG. 1.

FIG. 5 illustrates a side view of a pair of heat transfer plates that may be included in some embodiments of a thermal energy storage system described herein.

FIG. 6 illustrates a sectional view of a heat transfer plate that may be included in some embodiments of a thermal energy storage system described herein.

FIG. 7 illustrates an exploded perspective view of a thermal energy storage system according to one embodiment described herein.

FIG. 8 illustrates a sectional side view of the thermal energy storage system of FIG. 7.

FIG. 9 illustrates a perspective view of a heat exchanger that may be included in some embodiments of a thermal energy storage system described herein.

FIG. 10A illustrates a perspective view of a thermal energy storage system according to one embodiment described herein.

FIG. 10B illustrates a perspective view of a thermal energy storage system according to one embodiment described herein.

FIG. 10C illustrates a perspective view of a thermal energy storage system according to one embodiment described herein.

FIG. 10D illustrates a perspective view of a thermal energy storage system according to one embodiment described herein.

FIG. 11A illustrates a perspective view of a thermal energy management system comprising a stack of three thermal energy storage systems, in accordance with one embodiment described herein.

FIG. 11B illustrates a perspective view of a thermal energy management system having twelve thermal energy storage systems, in accordance with one embodiment described herein.

FIG. 12 illustrates a graphical representation of a typical load profile of an industrial thermal system.

FIG. 13 is a schematic comparison of a thermal energy storage system according to embodiments described herein in comparison to an ice storage system.

FIG. 14A illustrates a perspective partial cutaway view of the heat exchanger for a thermal energy storage system according to some embodiments described herein.

FIG. 14B illustrates a perspective view of an interior receiving space of the heat exchanger of FIG. 14A having a plurality of heat exchanger plates embedded in PCM.

FIG. 15 illustrates a plan view of an exemplary heat exchange plate showing surface channels.

FIG. 16 is a graph showing pressure drop as a function of various mass flow rates across a bundle of 20 heat exchange plates.

FIG. 17A illustrates a perspective view of heat exchanger plate spacing at 2 inches (5.08 cm) apart.

FIG. 17B illustrates a plan view of the heat exchanger plates of FIG. 17A.

FIG. 18A illustrates a perspective view of heat exchanger plate spacing at 1 inch (2.54 cm) apart.

FIG. 18B illustrates a plan view of the heat exchanger plates of FIG. 18A.

FIG. 19 is a graph of measured thermal conductivities and R-values of an exemplary heat exchanger vessel.

FIG. 20 is a schematic of an exemplary experimental facility comprising a thermal energy storage system according to embodiments described herein.

FIG. 21 is a graph of the melting and freezing phase transition of hexadecane.

FIG. 22 is a graph of outlet temperature profiles of different heat exchanger plate-plate spacing arrangements in a heat exchanger.

FIG. 23A is a perspective view of a thin film of PCM at the surface of heat exchanger plates during a discharge cycle using 2-inch plate spacing.

FIG. 23B is a perspective view of a thin film of PCM at the surface of heat exchanger plates after complete discharged (frozen) PCM using 1-inch plate spacing.

FIGS. 24A, 24B, and 24C are each graphs comparing various outlet water temperature profiles with respect to time during the melting cycle at various flow rates and inlet water temperatures for a heat exchanger according to embodiments described herein.

FIGS. 25A, 25B, and 25C are each graphs showing cumulative energy storage profiles at various inlet conditions for a heat exchanger according to embodiments described herein.

FIGS. 26A and 26B are graphs of a heat transfer coefficient at different conditions for a heat exchanger according to embodiments described herein.

FIGS. 27A and 27B are graphs showing the effectiveness at various inlet conditions of a heat exchanger according to embodiments described herein.

FIGS. 28A and 28B are graphs showing outlet temperature as a function of transitioning, inlet temperature and flow rate for a heat exchanger according to embodiments described herein.

FIG. 29 is a graph of discharge (freezing) profiles for various inlet conditions for a heat exchanger according to embodiments described herein.

FIG. 30 is a graph of a number of heat exchanger units according to embodiments described herein as a function of thermal load at various conditions.

FIGS. 31-40 respectively illustrate Tables 1-10, and FIGS. 41-49 respectively illustrate equations 1-9.

### DETAILED DESCRIPTION

Implementations and embodiments described herein can be understood more readily by reference to the following detailed description, examples, and drawings. Elements, apparatus, and methods described herein, however, are not limited to the specific implementations presented in the detailed description, examples, and drawings. It should be recognized that these implementations are merely illustrative of the principles of the present disclosure. Numerous modifications and adaptations will be readily apparent to those of skill in the art without departing from the spirit and scope of the disclosure. In addition, all ranges disclosed herein are to be understood to encompass any and all subranges subsumed therein. For example, a stated range of “1.0 to 10.0” should be considered to include any and all subranges beginning with a minimum of 1.0 or more and ending with a maximum value of 10.0 or less, e.g., 1.0 to 5.3, or 4.7 to 10.0, or 3.6 to 7.9. Similarly, as will be clearly understood, a stated range of “1 to 10” should be considered to include any and all subranges beginning with a minimum of 1 or more and ending with a maximum value of 10 or less, e.g., 1 to 6, or 7 to 10, or 3.6 to 7.9.

All ranges disclosed herein are also to be considered to include the end points of the range, unless expressly stated otherwise. For example, a range of between 5 and 10, from 5 to 10, or 5-10 should generally be considered to include the end points of 5 and 10.

### I. Thermal Energy Storage and Management Systems

In one aspect, thermal energy storage and/or management systems are described herein. In some embodiments, a thermal energy storage system described herein comprises a container, a heat exchanger disposed within the container, and a PCM disposed within the container, wherein the heat exchanger comprises an inlet pipe or header, an outlet pipe or header, and a number n of thermal transfer or heat exchange plates in fluid communication with the inlet pipe and the outlet pipe such that a fluid flowing from the inlet pipe and to the outlet pipe flows through the plates in between the inlet pipe and the outlet pipe, wherein the PCM is in thermal contact with the plates, and wherein the number n is at least 2. In some cases, the number n is at least 5, at least 10, at least 20, or at least 50. In some instance, the number n is between 2 and 500, between 2 and 250, between 2 and 100, between 5 and 500, between 5 and 100, between 10 and 200, between 10 and 100, between 10 and 40, between 20 and 200, or between 20 and 100.

However, the number of plates is not particularly limited and can be chosen based on the overall dimensions of the container, the spacing between plates, the amount of PCM, and/or the desired latent heat capacity of the system. Moreover, as described above, it is to be understood that fluid generally enters the heat exchanger apparatus through a “proximal” end of the inlet pipe and generally exits the heat exchange apparatus through a “distal” end of the outlet pipe or (in some cases) through a distal end of the inlet pipe. Additionally, in some instances, a fluid flowing into the inlet pipe and out of the outlet pipe flows through at least a portion of the plates or through some of the plates after flowing into the inlet pipe but before flowing out of the outlet pipe. Further details regarding the configuration, operation, and use of systems described herein is provided below, including with reference to the drawings and specific examples and implementations.

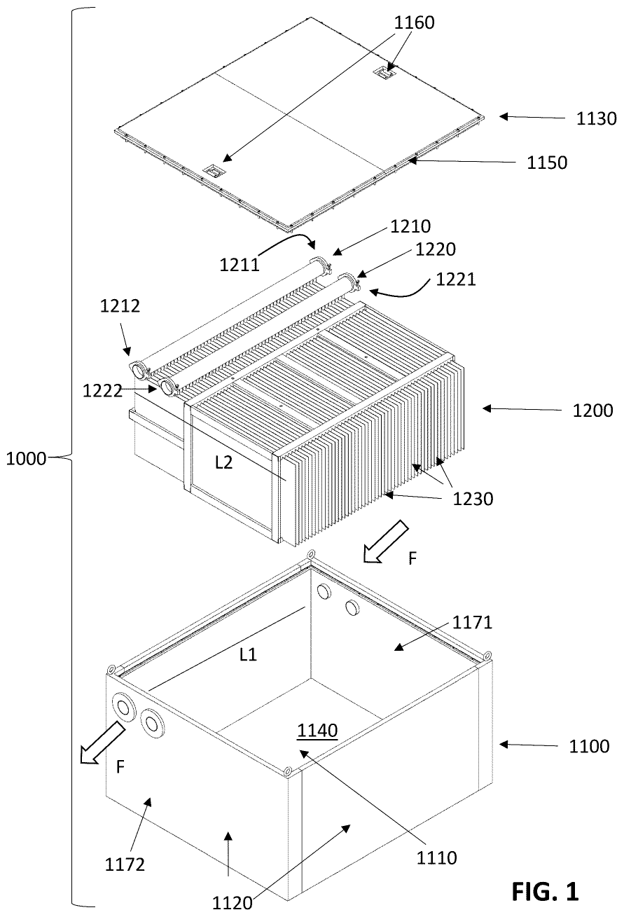

Briefly, with reference to the drawings, FIG. 1 illustrates an exploded perspective view of one non-limiting, exemplary embodiment of a thermal energy storage system described herein. As illustrated in FIG. 1, a thermal energy storage system (1000) comprises a container (1100), a heat exchanger (1200) disposed within the container (1100), and a PCM (not shown) disposed within the container (1100). The container (1100) is defined by a floor (1110), side walls (1120), and a cover (1130). It should be noted that FIG. 1 illustrates an exploded view, in which the heat exchanger (1200) is illustrated above the container (1100) for clarity, and in which the cover (1130) is illustrated above the heat exchanger (1200) for clarity. As understood by one of ordinary skill in the art, the heat exchanger (1200) is disposed within the container (1100) (more specifically, within the interior volume (1140) of the container (1100)) in an assembled system (1000), and the cover (1130) serves to enclose the interior (1140) of the assembled system (1000).

It should further be noted that the PCM is not explicitly shown for clarity. However, in the embodiment of FIG. 1, the PCM would occupy a portion of the interior volume (1140) of the container (1100) that is not occupied by the heat exchanger (1200). More specifically, the heat exchanger (1200) can be considered to be “immersed” or“embedded” in a“pool” or “block” of the PCM. The “pool” or“block” of PCM, in some cases, could “rise” or extend from the floor (1110) of the container (1100) to a level within the interior volume (1140) corresponding to line “L1” illustrated on the container (1100), or corresponding to line “L2” illustrated on the heat exchanger (1200), or corresponding to some other “fill level,” where the “fill level” may be selected based on a desired degree of “immersion” of the plates (1230) of the heat exchanger (1200), based on a desired thermal mass or latent heat capacity of the PCM, and/or based on ease of installation or maintenance of the system (1000). It is to be understood that the PCM is in thermal contact with the plates (1230), such as may be especially provided by direct physical contact between the PCM and exterior surfaces of the plates (1230). As illustrated in FIG. 1, the number n of plates (1230) is about 52. However, as described herein, other numbers of plates may also be used.

As illustrated in FIG. 1, the heat exchanger (1200) comprises an inlet pipe or header (1210), an outlet pipe or header (1220), and a number n of plates (1230) in fluid communication with the inlet pipe (1210) and the outlet pipe (1220). Exemplary details regarding fixtures, openings, or apertures connecting the inlet pipe (1210) and the outlet pipe (1220) to the plates (1230) are described further hereinbelow. A flowing fluid (represented by arrows F in FIG. 1) that flows from the inlet pipe (1210) to the outlet pipe (1220) flows through the plates (1230) in between the inlet pipe (1210) and the outlet pipe (1220). As illustrated schematically by the arrows F in FIG. 1 and as further described herein, the fluid (F) can generally enter the heat exchange apparatus (1200) through a “proximal” end (1211) of the inlet pipe (1210) and generally exit the heat exchange apparatus (1200) through a “distal” end (1222) of the outlet pipe (1220) or (in some cases) through a distal end (1212) of the inlet pipe (1210). It should further be noted that the assignment of a specific pipe or header as the “inlet” or“outlet” pipe is not necessarily fixed, but instead can be based on the direction of flow of a fluid in a specific instance. Thus, it should be generally understood that the inlet pipe (1210) and the outlet pipe (1220) could be reversed in terms of their position in the structure of the heat exchanger (1200) without changing the principles of operation of the system (1000). Likewise, the direction of flow of the fluid (F) could be reversed without changing the principles of operation of the system (1000).

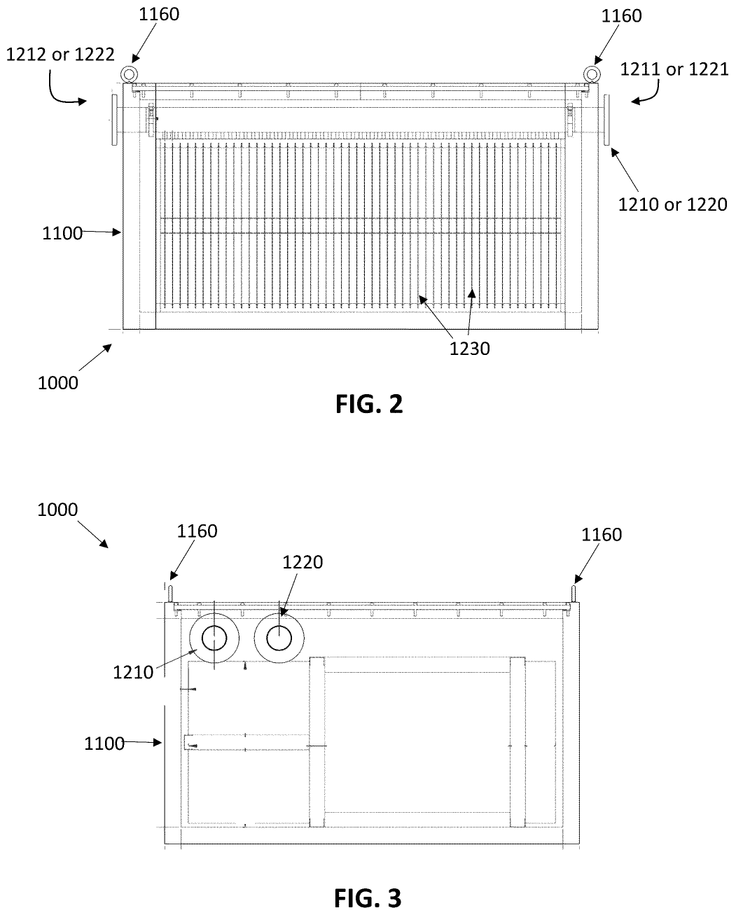

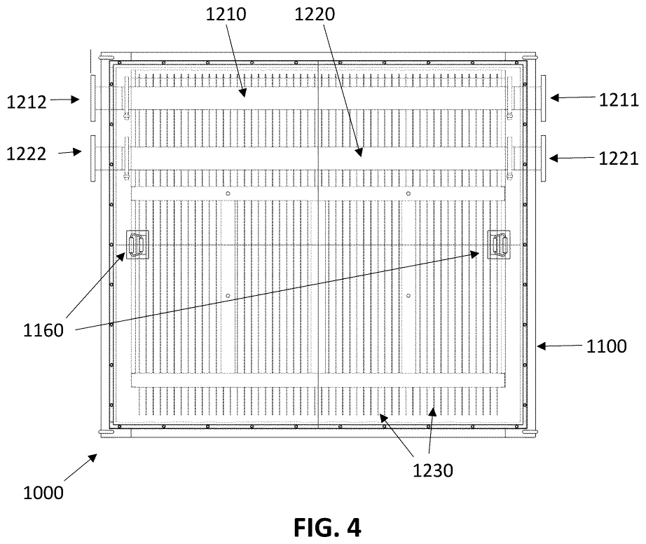

Additional views of the thermal energy storage system (1000) of FIG. 1 are provided in FIGS. 2-4, in which similar reference numbers denote similar features as in FIG. 1, and in which the thermal energy storage system (1000) is depicted in non-exploded (i.e., “assembled”) views. FIG. 2 illustrates a sectional side view of the thermal energy storage system of FIG. 1. FIG. 3 illustrates a view of a side adjacent to the side illustrated sectionally in FIG. 2. FIG. 4 illustrates a top plan view of the thermal energy storage system of FIG. 1.

Specific components of thermal energy storage systems described herein will now be described in more detail. Systems described herein comprise a container. Any container not inconsistent with the objectives of the present disclosure may be used. Moreover, the container can have any size, shape, and dimensions and be formed from any material or combination of materials not inconsistent with the objectives of the present disclosure. In some embodiments, for example, the container is made from one or more weather-resistant materials, thereby permitting installation of the system in an outdoor environment. In some cases, the container is metal or formed from a metal or a mixture or alloy of metals, such as iron or steel. In other instances, the container is formed from plastic or a composite material, such as a composite fiber or fiberglass material. In some cases, the container is formed from a polyolefin such as polypropylene or polyethylene, including a high density polyolefin such as high density polyethylene (HDPE).

Additionally, in some instances, the container of a system described herein provides functionality beyond containment of the PCM and heat exchanger. For example, in some cases, a container comprises exterior walls, interior walls, and a thermally insulating material disposed in between the exterior walls and the interior walls. Any thermally insulating material not inconsistent with the objectives of the present disclosure may be used. In some embodiments, the thermally insulating material is air or a vacuum. In other cases, the thermally insulating material comprises a foam, such as a polyisocyanurate foam. Further, in some instances, the exterior walls and/or the interior walls of the container are formed from a metal, plastic, composite material, or a combination of two or more of the foregoing. It is further to be understood that such exterior and interior walls (as well as anything disposed between them, such as a thermally insulating material) can together form each “side wall” and“floor” of the container, as the “side walls” and“floor” are denoted in FIG. 1. Similarly, in some instances, a cover of a container described herein likewise comprises exterior walls, interior walls, and a thermally insulating material disposed in between the exterior walls and interior walls. Further, in some implementations, the “cover” as denoted in FIG. 1 is formed from such amulet layered” or composite cover, though the individual layers (e.g., the thermally insulating material disposed within the cover) are not expressly shown in FIG. 1.

Moreover, in some embodiments described herein, the floor, side walls, and/or cover of the container have an R-value of at least 4 square-foot*degree Fahrenheit*hour per British thermal unit per inch (ft²*° F.*h/BTU*inch). In some cases, the floor, side walls, and/or cover of the container have an R-value of at least 5, at least 6, or at least 8 (ft²*° F.*h/BTU*inch). In some instances, the R-value of the floor, side walls, and/or cover is between 4 and 10, between 4 and 8, between 4 and 6, between 5 and 10, between 5 and 8, or between 6 and 10 (ft²*° F.*h/BTU*inch).

Additionally, in some cases, a gasket, seal, or sealing layer is disposed between the cover and the side walls of a container described herein, or is disposed within or forms part of the cover. Such a gasket may be part of the main body of the container, or part of the cover of the container. Further, such a gasket can provide further thermal insulation and/or protection of the interior volume of the container from external factors such as water or other materials that may be present in the exterior environment of the container/system, particularly when the container/system is disposed or installed outdoors. The container of a system described herein may also include or comprise lugs or other features on one or more exterior surfaces of the container, such as one or more detachable lifting lugs disposed on one or more exterior surfaces of the container. FIG. 1 illustrates non-limiting examples of a gasket (1150) and lifting lugs (1160) of a container (1100).

Moreover, in some preferred embodiments, it is particularly to be noted that the container is not a standard shipping container. For example, in some embodiments, the container is not a container specifically approved by the Department of Transportation for shipping, such as a container having exterior dimensions of 20 feet by 8 feet by 8 feet. A container for use in a thermal energy storage system described herein, in some embodiments, can have other dimensions. The size and shape of the container, in some embodiments, are selected based on one or more of a desired thermal energy storage capacity of the system, a desired footprint of the system, and a desired stackability or portability of the system. For example, although the container is not itself a standard shipping container, it is to be understood that a container of a thermal energy management system described herein can be fitted or placed inside of a standard shipping container, such as for ease of shipment or transport of the system. In some preferred embodiments, the container of a thermal energy management system described herein has overall length, width, and height dimensions that permit two containers of two separate systems to be stacked on top of another (two high) and then placed within a standard shipping container.

Further, in some cases, the overall dimensions of each container of each separate system are selected to permit an integral number (e.g., 4, 5, or 6) of “two-high” stacks to be placed or fitted within the interior of a standard shipping container. However, the exterior dimensions of the container of a thermal energy storage system described herein are not particularly limited, and other dimensions may also be used.

Turning now to the relationship between the container of a system described herein and the heat exchanger disposed within the container, it is to be understood that the heat exchanger or heat exchange apparatus can be disposed, installed, or fitted within the container (e.g., within or primarily within the interior volume of the container) in any manner not inconsistent with the objectives of the present disclosure. For example, in some cases, the entire volume or almost the entire volume of the heat exchanger is disposed within the interior space of the container, and only a small portion or only one or more connector portions of the heat exchanger are disposed or configured outside the container for purposes of providing access to the plates or other majority portion of the heat exchanger inside the container. In some embodiments, for instance, the inlet pipe of the heat exchanger (or a connector portion thereof) passes through (or partially through) an exterior wall of the container, thereby providing fluid communication between the plates and an exterior of the container. Similarly, in some cases, the outlet pipe (or a connector portion thereof) of the heat exchanger passes through (or partially through) an exterior wall of the container, thereby providing fluid communication between the plates and an exterior of the container.

As described further herein, it is to be understood that various exterior systems can be connected to the thermal energy management system, such that fluid communication is provided between the plates of the thermal energy management system and the exterior systems. For instance, in some cases, an HVAC chiller or source of waste heat (external to the thermal energy management system itself) is attached to or associated with the thermal energy management system.

In some preferred embodiments, with reference to FIG. 1, a first end (1211) of the inlet pipe (1210) of the heat exchanger (1200) passes through a first exterior wall (1171) of the container (1100), thereby providing fluid communication between the plates (1230) and an exterior of the container (1100).

A second end (1212) of the inlet pipe (1210), opposite the first end (1211), passes through a second exterior wall (1172) of the container (1100). Moreover, in some cases, a first end (1221) of the outlet pipe (1220) of the heat exchanger (1200) passes through the first exterior wall (1171) of the container (1100). A second end (1222) of the outlet pipe (1220), opposite the first end (1221), passes through the second exterior wall (1172) of the container (1100), thereby providing fluid communication between the plates (1230) and an exterior of the container (1100). Additionally, in some embodiments, the second end (1212) of the inlet pipe (1210) is capped or sealed or closed, such that fluid communication between the plates (1230) and an exterior of the container (1100) is prevented through the second end (1212) of the inlet pipe (1210). Further, in some cases, the first end (1221) of the outlet pipe (1220) is capped or sealed or closed, such that fluid communication between the plates (1230) and an exterior of the container (1100) is prevented through the first end (1221) of the outlet pipe (1220). As illustrated in FIG. 1, the first exterior wall (1171) of the container (1100) and the second exterior wall (1172) of the container (1100) are in facing opposition to one another.

Turning once again to certain preferred embodiments, in some cases, the n plates of a thermal energy storage system described herein are in fluid communication with the inlet pipe and the outlet pipe in parallel with one another. It is to be understood that heat exchange or thermal transfer plates that are arranged “in parallel” are each independently connected to the inlet and outlet pipes, such that a specific portion or “plug” of fluid flowing from the inlet pipe, through a given plate, and then into the outlet pipe flows through only that given plate (as opposed to flowing through more than one plate). This “in parallel” configuration differs from a “serial” or “in series” arrangement in which a specific portion of fluid flowing from the inlet pipe to the outlet pipe flows through a plurality of plates in between the inlet pipe and the outlet pipe. In other words, prior to entering the outlet pipe for the first time, the fluid flows through at least a first plate and also a second plate in sequence. Such a flow path would occur, for instance, if the first plate were in direct fluid communication with the second plate but not with the outlet pipe, such that fluid flowing through the first plate would be forced to also flow through the second plate prior to reaching the outlet pipe. In a “parallel” arrangement, each plate includes its “own” direct connection or fitting or orifice providing fluid communication to the inlet pipe, and also its “own” direct connection or fitting or orifice providing fluid communication to the outlet pipe. Thus, in some preferred embodiments, the n plates are not in fluid communication with the inlet pipe and the outlet pipe in series with one another, and are not in direct fluid communication with each other.

Moreover, in some instances, fluid flows through immediately adjacent plates in generally opposite or complementary directions. In some such cases, the fluid flows through immediately adjacent plates in opposite or complementary directions such that there is a counter flow condition in the adjacent plates. As described further herein, such a flow condition can be obtained when immediately adjacent plates have (generally)“mirrored” or opposite flow patterns or channels (e.g., where a first plate exhibits an “up-down-up-down” or “left-right-left-right” flow pattern, while the second, immediately adjacent plate exhibits a “down-up-down-up” or “right-left-right-left” flow pattern, where “up” and“down” and“left” and“right” are relative to gravity or to the floor of the container of the system). Further, for a set of n plates, in some cases, two “types” or patterns of plate can be used in an A-B-A-B alternating arrangement, thereby obtaining a flow pattern throughout all the plates that generally exhibits “counter flow” or alternating directional flow as a function of space or distance perpendicular to the major plane of the array or “stack” of plates. Counter flow could be achieved in other ways as well, as described further herein.

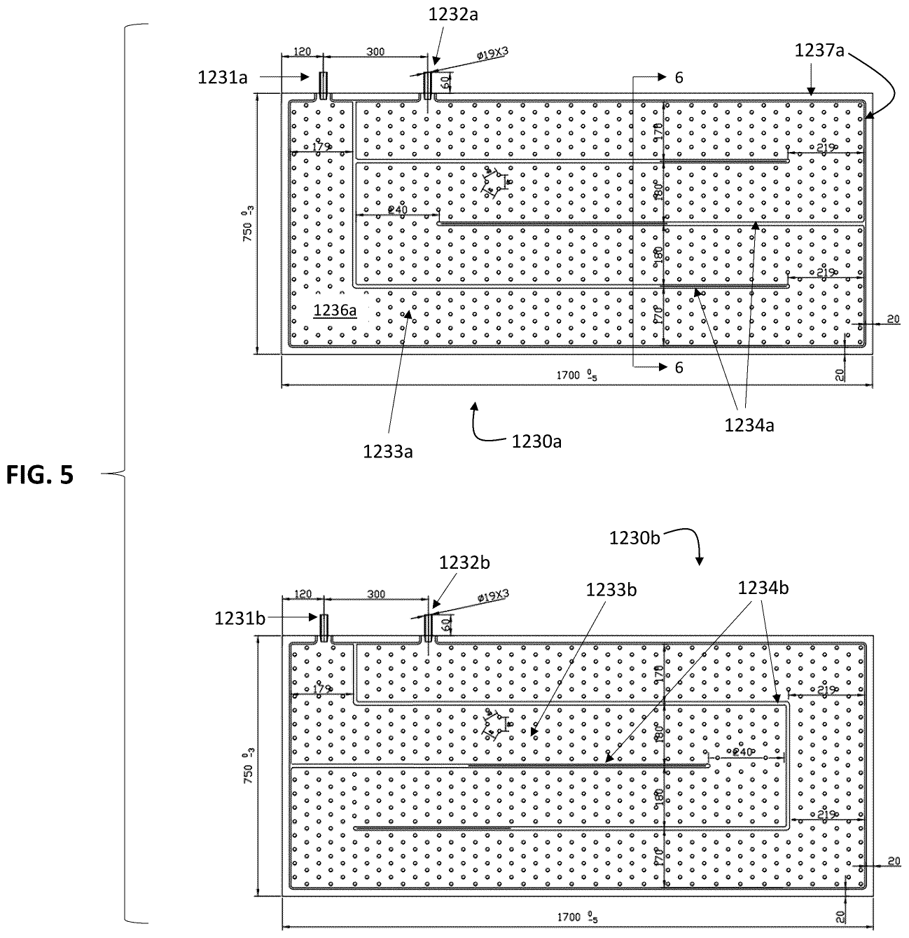

One non-limiting example of a “pair” of adjacent plates in which such counter flow can be achieved is illustrated in FIG. 5, which is a side view of two adjacent plates. With reference to FIG. 5, a first plate (1230a) comprises a first inlet orifice, fitting, or connection (1231a) and a first outlet, orifice, fitting, or connection (1232a). Fluid (not shown) flowing from the first inlet fitting (1231a) to the first outlet fitting (1232a) flows through a first flow path or channel (1233a). The first flow path or channel (1233a) is defined by first joined regions or barriers (1234a). The structure of such joined regions or barriers is described further hereinbelow. As illustrated in FIG. 5, the first flow path or channel (1233a) is a baffled flow path. Again with reference to FIG. 5, a second plate (1230b) is immediately adjacent to the first plate (1230a) when disposed in the heat exchanger (1200), though the plates (1230a, 1230b) are not depicted in this manner in FIG. 5, for purposes of clarity. The second plate (1230b) comprises a second inlet orifice, fitting, or connection (1231b) and a second outlet orifice, fitting, or connection (1232b). Fluid (not shown) flowing from the second inlet fitting (1231b) to the second outlet fitting (1232b) flows through a second flow path or channel (1233b). The second flow path or channel (1233b) is defined by second joined regions or barriers (1234b). Again, the structure of such joined regions or barriers is described further hereinbelow. Like the first flow path or channel (1233a), the second flow path or channel (1233b) is a baffled flow path.

Additionally, it can readily be observed that the first and second flow paths (1233a, 1233b) are opposite, complementary, or counter flowing, in the sense that fluid flowing along the paths (1233a, 1233b) take opposite, complementary, or counter flow “turns” or changes of direction. Not intending to be bound by theory, it is believed that such opposite, complementary, or counter flow paths in adjacent plates provides improved performance by more evenly distributing thermal energy exchange “events” or activity on the exterior surface of the plates and thus within the body of PCM disposed in the container. It is further believed that the thermal mass or latent heat of the totality of the PCM disposed in the container is therefore used more efficiently, as opposed to only some portions, areas, or volumes of PCM undergoing a heat transfer event (or phase change), while other portions, areas, or volumes of PCM are largely thermal “spectators.” [0067] Again turning to certain features of thermal energy storage systems described herein, in some preferred embodiments, the inlet pipe, the outlet pipe, and the n plates of a thermal energy storage system define n separate flow paths between the first (or proximal or inlet) end of the inlet pipe or heat exchanger and the second (or more distal or outlet) end of the outlet pipe or heat exchanger. Further, in some preferred embodiments, the n separate flow paths have the same or substantially the same length. For reference purposes herein, it is to be understood that a length, dimension, or other quantifiable unit or value described herein as “substantially” the same as another unit or value differs from the other unit or value by 10% or less, 5% or less, 3% or less, or 1% or less. Similarly, in some cases, the n plates have n flow velocities within the plates, and the n flow velocities have the same or substantially the same magnitude. Not intending to be bound by theory, it is believed that such uniformity or substantial uniformity of flow path and/or flow velocity within the heat exchanger can be provided by the structure of the inlet and outlet pipes and the structure of the heat transfer plates described herein, including with respect to how the inlet pipe, outlet pipe, and plates are connected to one another and with respect to the “opening” or“closing” of possible flow paths within the heat exchanger. Again not intending to be bound by theory, it is believed that uniform or substantially uniform flow paths and/or flow velocities can in turn provide improved thermal energy exchange between the PCM and the fluid flowing through the system.

Thermal energy storage systems described herein can also avoid undesired pressure drop exhibited by some other systems. In some embodiments, the n plates are connected to the inlet pipe by n inlet fittings, and the cross-sectional area of the inlet pipe is at least 0.8 times the total cross-sectional areas of the n inlet fittings combined, or is greater than or equal to the total cross-sectional areas of the n inlet fittings combined. In some instances, the cross-sectional area of the inlet pipe is greater than the total cross-sectional areas of the n inlet fittings combined. Moreover, in some cases, the n plates are connected to the outlet pipe by n outlet fittings, and the cross-sectional area of the outlet pipe is at least 0.8 times the total cross-sectional areas of the n outlet fittings combined, or is greater than or equal to the total cross-sectional areas of the n outlet fittings combined. In some embodiments, the cross-sectional area of the outlet pipe is greater than the total cross-sectional areas of the n outlet fittings combined.

Additionally, in some cases, the plates (or each plate, or one or more of the plates) of a thermal energy storage system described herein have or are defined by two heat transfer surfaces in facing opposition to one another, the two heat transfer surfaces being joined to one another to form four edges. Further, the edges can be relatively thin compared to the heat transfer surfaces. For instance, in some cases, the average length and the average width of the two heat transfer surfaces are at least 50 times, at least 100 times, at least 200 times, or at least 500 times the average thickness of the four edges. In some cases, the average length and the average width of the two heat transfer surfaces are 50-1000, 50-500, 100-1000, or 100-500 times the average thickness of the four edges.

Moreover, as described above, the two heat transfer surfaces can define one or more interior fluid flow channels, in between the two surfaces. Such flow channels or paths are illustrated, for instance, in FIG. 5. As described above, in some cases, the one or more channels include includes a plurality of baffles or switchbacks, or have a baffle structure. Moreover, in some embodiments, the one or more channels are defined by a plurality of joined or “sealed” regions of the two heat transfer surfaces, such as may be provided, for instance, by regions where the surfaces are welded together (e.g., by laser welding) or joined with one or more mechanical fasteners (e g., rivets), provided that the joined or sealed regions do not permit flow or substantial flow of the fluid across or through the regions (that is, the regions act as barriers to fluid flow).

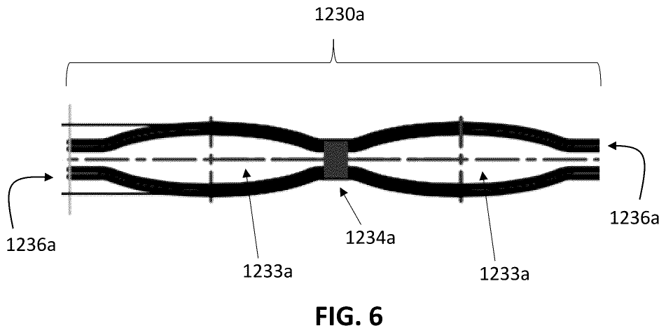

The foregoing features may be further understood with reference to FIG. 6, which illustrates a sectional view of a portion of a single plate (e.g., plate 1230a in FIG. 5), where the section is taken, for instance, along line 6-6 in FIG. 5. In FIG. 6, the plate (1230a) has two heat transfer surfaces (1236a in FIG. 5 and FIG. 6) in facing opposition to one another, the two heat transfer surfaces (1236a) being joined to one another to form edges (1237a in FIG. 5) at or around the perimeter of the plate. The two heat transfer surfaces (1236a) define one or more interior fluid flow channels (1233a; in FIG. 6, two channels or portions of a single channel are shown) in between the two surfaces (1236a). The one or more channels are defined by a plurality of joined and “sealed” regions (1234a; in FIG. 6, one joined or sealed region is shown: in FIG. 5, the joined or sealed regions are more readily observed to define “lines,” barriers, or flow paths).

In addition, in preferred embodiments of a thermal energy storage system described herein, the plates of the heat exchanger are substantially parallel to one another (here, “parallel” refers to spatial alignment, as opposed to the use of “in parallel” hereinabove, which referred to flow path). As described above, it is to be understood that two or more plates that are “substantially” parallel to one another are offset or off-axis by less than about 10 degrees, less than about 5 degrees, less than about 3 degrees, or less than about 1 degree. Such parallel plates are readily observed in FIGS. 1, 2, and 4, for instance. Moreover, in some cases, the plates are spaced apart from one another by an average distance (d) defined by one of Equations (1)-(3):

$$d = 0.28 k + 1.33 , for 0.01 < k < 0.4 ; \qquad Equation ( 1 )$$

$$d = 0. 23 k + 1.34 , for 0.41 < k < 1. ; and \qquad Equation ( 2 )$$

$$d = 0. 12 k + 1.44 , for k > 1.01 , \qquad Equation ( 3 )$$

where d is the numeric value of the average plate-to-plate distance when expressed in units of inches and k is the numeric value of the thermal conductivity when expressed in units of W/(m*K) of the phase change material in contact with the plates. Applicant has discovered that such an average spacing of parallel plates described herein can improve system performance. Not intending to be bound by theory, it is believed that an average spacing described herein can improve the efficiency and homogeneity of thermal energy transfer and phase change events/activity through the total mass or body of PCM disposed in the system. It is further to be understood that the plates of a heat exchanger described herein can be formed from any material not inconsistent with the objectives of the present disclosure. In some cases, for instance, the plates are formed from metal.

Turning now to the phase change material of a thermal energy storage system described herein, the PCM, in some preferred embodiments, is in direct physical contact with heat exchange surfaces of the plates. For example, in some cases, as described above, the heat exchanger is at least partially embedded in the phase change material.

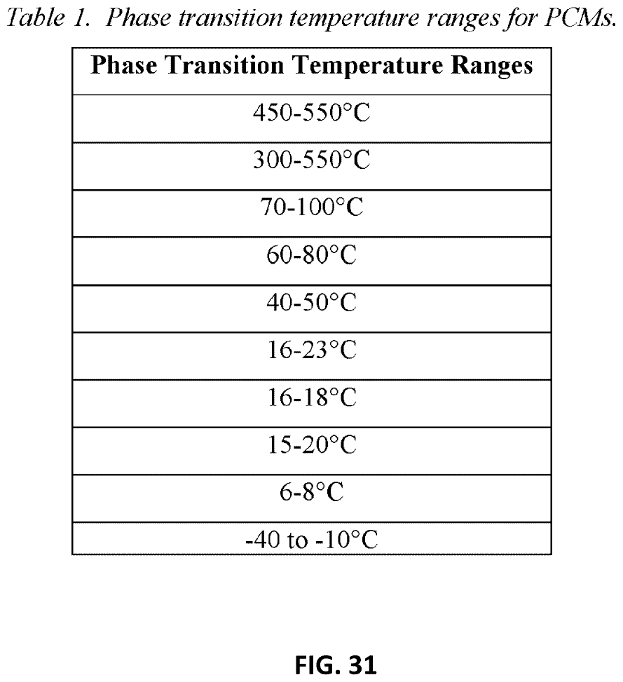

Any PCM not inconsistent with the objectives of the present disclosure may be used in a thermal energy storage system described herein. Moreover, the PCM (or combination of PCMs) used in a particular instance can be selected based on a relevant operational temperature range for the specific end use or application. For example, in some cases, the PCM has a phase transition temperature within a range suitable for heating or cooling a residential or commercial building. In other instance, the PCM has a phase transition temperature suitable for the thermal energy management of so-called waste heat. In some embodiments, the PCM has a phase transition temperature within one of the ranges of Table 1 of FIG. 31.

As described further herein, a particular range can be selected based on the desired application. For example, PCMs having a phase transition temperature of 15-20° C. can be especially desirable to assist in the cooling of nuclear reactor fuel rod cooling pools, while PCMs having a phase transition temperature of 6-8° C. can be especially desirable for HVAC energy storage support. As another non-limiting example. PCMs having a phase transition between −40° C. and −10° C. can be preferred for use in space applications or for support of commercial freezer cooling.

Further, a PCM of a thermal energy storage system described herein can either absorb or release energy using any phase transition not inconsistent with the objectives of the present disclosure. For example, the phase transition of a PCM described herein, in some embodiments, comprises a transition between a solid phase and a liquid phase of the PCM, or between a solid phase and a mesophase of the PCM. A mesophase, in some cases, is a gel phase. Thus, in some instances, a PCM undergoes a solid-to-gel transition.

Moreover, in some cases, a PCM or mixture of PCMs has a phase transition enthalpy of at least about 50 kJ/kg or at least about 100 kJ/kg. In other embodiments, a PCM or mixture of PCMs has a phase transition enthalpy of at least about 150 kJ/kg, at least about 200 kJ/kg, at least about 300 kJ/kg, or at least about 350 kJ/kg. In some instances, a PCM or mixture of PCMs has a phase transition enthalpy between about 50 kJ/kg and about 350 kJ/kg, between about 100 kJ/kg and about 350 kJ/kg, between about 100 kJ/kg and about 220 kJ/kg, or between about 100 kJ/kg and about 250 kJ/kg.

In addition, a PCM of a thermal energy storage system described herein can have any composition not inconsistent with the objectives of the present disclosure. In some embodiments, for instance, a PCM comprises an inorganic composition. In other cases, a PCM comprises an organic composition. In some instances, a PCM comprises a salt hydrate. Suitable salt hydrates include, without limitation, CaCh·6H2O, Ca(N03)2·3H2O, NaSCU·10H2O, Na(N03)₂·6H2O, Zn(N03)₂·2H₂O, FeCb·2H₂O, Co(N03)₂·6H₂O, Ni(N03)₂·6H₂O, MnCh·4H₂O, CftCOONa·3H₂O, LiC₂H₃O₂·2H₂O, MgCk·4H₂O, NaOH·H₂O, Cd(N03)₂·4H₂O, Cd(N03)₂·IH2O, Fe(N03)₂·6H2O, NaAl(SO₄)2·12H₂O, FeSCri·7H₂O, Na₃PO₄·12H2O, Na2B₄Ch·IOH2O, Na₃PO₄·12H2O, LiCFFCOO·2FbO, and/or mixtures thereof.

In other embodiments, a PCM comprises a fatty acid. A fatty acid, in some embodiments, can have a C4 to C28 aliphatic hydrocarbon tail. Further, in some embodiments, the hydrocarbon tail is saturated.

Alternatively, in other embodiments, the hydrocarbon tail is unsaturated. In some embodiments, the hydrocarbon tail can be branched or linear. Non limiting examples of fatty acids suitable for use in some embodiments described herein include caprylic acid, capric acid, lauric acid, myristic acid, palmitic acid, stearic acid, arachidic acid, behenic acid, lignoceric acid, and cerotic acid. In some embodiments, a PCM described herein comprises a combination, mixture, or plurality of differing fatty acids. For reference purposes herein, it is to be understood that a chemical species described as a “Cn” species (e.g., a “C4” species or a “C28” species) is a species of the identified type that includes exactly “n” carbon atoms. Thus, a C4 to C28 aliphatic hydrocarbon tail refers to a hydrocarbon tail that includes between 4 and 28 carbon atoms.

In some embodiments, a PCM comprises an alkyl ester of a fatty acid. Any alkyl ester not inconsistent with the objectives of the present disclosure may be used. For instance, in some embodiments, an alkyl ester comprises a methyl ester, ethyl ester, isopropyl ester, butyl ester, or hexyl ester of a fatty acid described herein. In other embodiments, an alkyl ester comprises a C2 to C6 ester alkyl backbone or a C6 to C12 ester alkyl backbone. In some embodiments, an alkyl ester comprises a C 12 to C28 ester alkyl backbone. Further, in some embodiments, a PCM comprises a combination, mixture, or plurality of differing alkyl esters of fatty acids. Non-limiting examples of alkyl esters of fatty acids suitable for use in some embodiments described herein include methyl laurate, methyl myristate, methyl palmitate, methyl stearate, methyl palmitoleate, methyl oleate, methyl linoleate, methyl docosahexanoate, methyl ecosapentanoate, ethyl laurate, ethyl myristate, ethyl palmitate, ethyl stearate, ethyl palmitoleate, ethyl oleate, ethyl linoleate, ethyl docosahexanoate, ethyl ecosapentanoate, isopropyl laurate, isopropyl myristate, isopropyl palmitate, isopropyl stearate, isopropyl palmitoleate, isopropyl oleate, isopropyl linoleate, isopropyl docosahexanoate, isopropyl ecosapentanoate, butyl laurate, butyl myristate, butyl palmitate, butyl stearate, butyl palmitoleate, butyl oleate, butyl linoleate, butyl docosahexanoate, butyl ecosapentanoate, hexyl laurate, hexyl myristate, hexyl palmitate, hexyl stearate, hexyl palmitoleate, hexyl oleate, hexyl linoleate, hexyl docosahexanoate, and hexyl ecosapentanoate.

In some embodiments, a PCM comprises a fatty alcohol. Any fatty alcohol not inconsistent with the objectives of the present disclosure may be used. For instance, a fatty alcohol, in some embodiments, can have a C4 to C28 aliphatic hydrocarbon tail. Further, in some embodiments, the hydrocarbon tail is saturated. Alternatively, in other embodiments, the hydrocarbon tail is unsaturated. The hydrocarbon tail can also be branched or linear. Non limiting examples of fatty alcohols suitable for use in some embodiments described herein include capryl alcohol, pelargonic alcohol, capric alcohol, undecyl alcohol, lauryl alcohol, tridecyl alcohol, myristyl alcohol, pentadecyl alcohol, cetyl alcohol, heptadecyl alcohol, stearyl alcohol, nonadecyl alcohol, arachidyl alcohol, heneicosyl alcohol, behenyl alcohol, lignoceryl alcohol, ceryl alcohol, and montanyl alcohol. In some embodiments, a PCM comprises a combination, mixture, or plurality of differing fatty alcohols.

In some embodiments, a PCM comprises a fatty carbonate ester, sulfonate, or phosphonate. Any fatty carbonate ester, sulfonate, or phosphonate not inconsistent with the objectives of the present disclosure may be used. In some embodiments, a PCM comprises a C4 to C28 alkyl carbonate ester, sulfonate, or phosphonate. In some embodiments, a PCM comprises a C4 to C28 alkenyl carbonate ester, sulfonate, or phosphonate. In some embodiments, a PCM comprises a combination, mixture, or plurality of differing fatty carbonate esters, sulfonates, or phosphonates. In addition, a fatty carbonate ester described herein can have two alkyl or alkenyl groups described herein or only one alkyl or alkenyl group described herein.

Moreover, in some embodiments, a PCM comprises a paraffin. Any paraffin not inconsistent with the objectives of the present disclosure may be used. In some embodiments, a PCM comprises n-dodecane, n-tridecane, n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, n-octacosane, n-nonacosane, n-triacontane, n-hentriacontane, n-dotriacontane, n-tritriacontane, and/or mixtures thereof.

In addition, in some embodiments, a PCM comprises a polymeric material. Any polymeric material not inconsistent with the objectives of the present disclosure may be used. Non-limiting examples of suitable polymeric materials for use in some embodiments described herein include thermoplastic polymers (e.g., poly(vinyl ethyl ether), poly(vinyl n-butyl ether) and polychloroprene), polyethylene glycols (e.g., CARBOWAX® polyethylene glycol 400, CARBOWAX® polyethylene glycol 600. CARBOWAX® polyethylene glycol 1000, CARBOWAX® polyethylene glycol 1500. CARBOWAX® polyethylene glycol 4600, CARBOWAX® polyethylene glycol 8000, and CARBOWAX® polyethylene glycol 14,000), and polyolefins (e.g., lightly crosslinked polyethylene and/or high density polyethylene).

Additional non-limiting examples of phase change materials suitable for use in some embodiments described herein include BioPCM materials commercially available from Phase Change Energy Solutions (Asheboro, North Carolina), such as BioPCM-(-8), BioPCM-(-6), BioPCM-(-4), BioPCM-(-2), BioPCM-4, BioPCM-6, BioPCM 08, BioPCM-Q12, BioPCM-Q15, BioPCM-Q18, BioPCM-Q20, BioPCM-Q21, BioPCM-Q23, BioPCM-Q25, BioPCM-Q27, BioPCM-Q30, BioPCM-Q32, BioPCM-Q35, BioPCM-Q37, BioPCM-Q42, BioPCM-Q49, BioPCM-55, BioPCM-60, BioPCM-62, BioPCM-65, BioPCM-69, and others.

It is further to be understood that a thermal energy storage system described herein can comprise a plurality of differing PCMs, including differing PCMs of differing types. Any mixture or combination of differing PCMs not inconsistent with the objectives of the present disclosure may be used. In some embodiments, for example, a thermal energy storage system comprises one or more fatty acids and one or more fatty alcohols. Further, as described above, a plurality of differing PCMs, in some cases, is selected based on a desired phase transition temperature and/or latent heat of the mixture of PCMs.

Further, in some embodiments, one or more properties of a PCM described herein can be modified by the inclusion of one or more additives. Such an additive described herein can be mixed with a PCM and/or disposed in a thermal energy storage system described herein. In some embodiments, an additive comprises a thermal conductivity modulator. A thermal conductivity modulator, in some embodiments, increases the thermal conductivity of the PCM.

In some embodiments, a thermal conductivity modulator comprises carbon, including graphitic carbon. In some embodiments, a thermal conductivity modulator comprises carbon black and/or carbon nanoparticles. Carbon nanoparticles, in some embodiments, comprise carbon nanotubes and/or fullerenes. In some embodiments, a thermal conductivity modulator comprises a graphitic matrix structure. In other embodiments, a thermal conductivity modulator comprises an ionic liquid. In some embodiments, a thermal conductivity modulator comprises a metal, including a pure metal or a combination, mixture, or alloy of metals. Any metal not inconsistent with the objectives of the present disclosure may be used. In some embodiments, a metal comprises a transition metal, such as silver or copper. In some embodiments, a metal comprises an element from Group 13 or Group 14 of the periodic table. In some embodiments, a metal comprises aluminum. In some embodiments, a thermal conductivity modulator comprises a metallic filler dispersed within a matrix formed by the PCM. In some embodiments, a thermal conductivity modulator comprises a metal matrix structure or cage-like structure, a metal tube, a metal plate, and/or metal shavings. Further, in some embodiments, a thermal conductivity modulator comprises a metal oxide. Any metal oxide not inconsistent with the objectives of the present disclosure may be used. In some embodiments, a metal oxide comprises a transition metal oxide. In some embodiments, a metal oxide comprises alumina.

In other embodiments, an additive comprises a nucleating agent. A nucleating agent, in some embodiments, can help avoid subcooling, particularly for PCMs comprising finely distributed phases, such as fatty alcohols, paraffinic alcohols, amines, and paraffins. Any nucleating agent not inconsistent with the objectives of the present disclosure may be used.

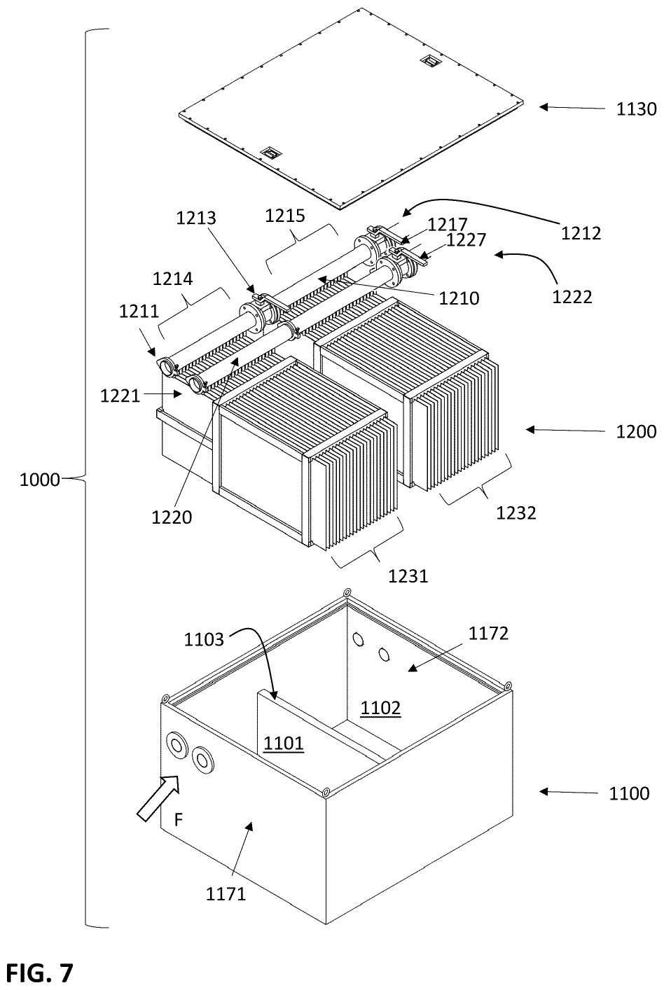

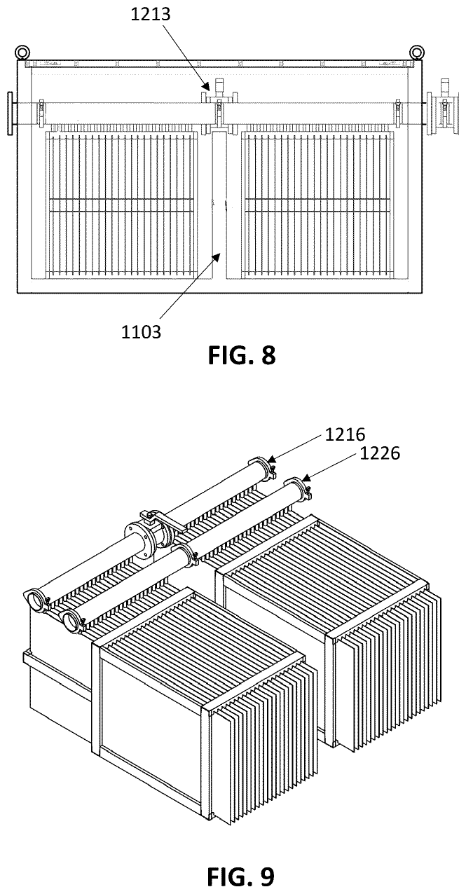

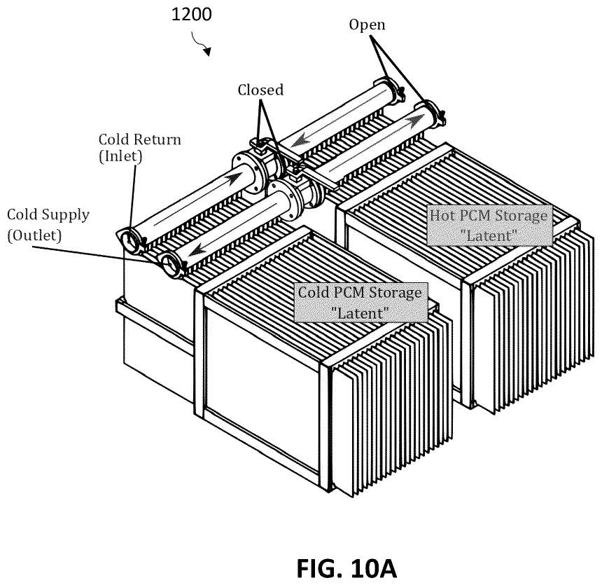

Exemplary implementations of thermal energy storage systems have been described above. In another embodiment, a thermal energy storage system described herein comprises a container that is subdivided into multiple compartments. One non-limiting example of such a system is illustrated in FIG. 7 and FIG. 8, with a further embodiment illustrated in FIG. 9. It should be noted that the reference numbers used in FIGS. 7-9 correspond, where relevant, to those used in FIGS. 1-4. It should further be noted that, for the sake of clarity of illustration, not all features are labeled in FIGS. 7-9.

With reference to FIGS. 7-9, the container (1100) of thermal energy storage system (1000) comprises a first chamber (1101) and a second chamber (1102) separated by a divider wall (1103) extending from the bottom toward the top of the container (1100). As illustrated in FIG. 7 and FIG. 8, the divider wall (1103) does not extend the entire distance between the top and bottom of the container (1100). The height of the divider wall (1103) instead matches or corresponds to the height or top of the heat exchanger (1200) disposed in the container (1100), or to a slightly larger height. A divider wall (1103) having such a height or extension in the vertical direction can effectively divide and sequester PCMs or PCM portions disposed in the two chambers (1101, 1102) while also not interfering with the configuration of the inlet pipe (1210) and the outlet pipe (1220). However, it is to be understood that a divider wall of a system described herein can have other structures also. It is further to be understood that, in some cases, the divider wall is thermally insulating or is formed from or contains a thermally insulating material, such as a foam.

Turning again to FIGS. 7-9, a first portion (1231) of the n plates (1230) is disposed in the first chamber (1101), and a second portion (1232) of the n plates (1230) is disposed in the second chamber (1102). The inlet pipe (1210) comprises a first valve (1213) having an open position and a closed position (the closed position is depicted in FIG. 7, in which a switch valve is depicted, such as a 4-inch switch valve). The valve (1213) divides the inlet pipe (1210) into a first portion (1214) and a second portion (1215). Further, the first valve (1213) is substantially aligned with the divider wall (1103), in terms of its placement along the direction defined by the long axis of the inlet pipe (1210). A first end (1211) of the inlet pipe (1210) passes through a first exterior wall (1171) of the container (1100), and a second end (1212) of the inlet pipe (1210), opposite the first end (1211), passes through a second exterior wall (1172) of the container (1100). Additionally, a first end (1221) of the outlet pipe (1220) passes through the first exterior wall (1171) of the container (1100). A second end (1222) of the outlet pipe (1220), opposite the first end (1221), passes through the second exterior wall (1172) of the container (1100). Moreover, the second end (1212) of the inlet pipe (1210) has an open configuration and a closed configuration. The second end (1222) of the outlet pipe (1220) also has an open configuration and a closed configuration.

The open and closed configurations of an end of an inlet pipe or outlet pipe can be provided by various structures or configurations. For example, in some cases, a closed configuration is provided by placement of a blind flange (or similar structure) over an end of a pipe, and an open configuration is provided by removal or the absence of the blind flange (or structure), such that the end of the pipe is not blocked or sealed. In other instances, a closed configuration is provided by a valve (such as a switch valve or valved flange) in a closed position of the valve, and the open position is provided by the open position of the valve.

With reference to FIG. 9, in some cases the closed configuration of the second end (1212) of the inlet pipe (1210) is provided by a blind flange (1216) disposed over the second end (1212) of the inlet pipe (1210); and/or the closed configuration of the second end (1222) of the outlet pipe (1220) is provided by a blind flange (1226) disposed over the second end (1222) of the outlet pipe (1220). Alternatively, with reference to FIG. 7, the open configuration and the closed configuration of the second end (1212) of the inlet pipe (1210) are provided by a second valve (1217) disposed at the second end (1212) of the inlet pipe (1210), the second valve (1217) having an open position and a closed position; and/or the open configuration and the closed configuration of the second end (1222) of the outlet pipe (1220) are provided by a third valve (1227) disposed at the second end (1222) of the outlet pipe (1220), the third valve (1227) having an open position and a closed position. Any suitable valve not inconsistent with the objectives of the present disclosure may be used. In some embodiments, for example, the second valve is a flanged valve, and/or the third valve is a flanged valve.

Systems such as described above can be multifunctional and can operate in different modes. For example, in some cases, the first end of the outlet pipe is closed or sealed (e.g., by a blind flange, a closed valve, or otherwise). Moreover, when the first valve is in the open position, the second end of the inlet pipe is in the closed configuration (e.g., because the blind flange is present or the second valve is in the closed position), and the second end of the outlet pipe is in the open configuration (e.g., because a blind flange is not disposed over the second end of the outlet pipe, or the third valve is in the open position), fluid flows simultaneously from both the first portion of the inlet pipe and also from the second portion of the inlet pipe, through both the first portion of the n plates and also through the second portion of the n plates, and then from the first portion of the n plates and also the second portion of the n plates into the outlet pipe. Such a fluid flow is similar to the fluid flow of the embodiment of FIG. 1.

Alternatively, if the first valve is in the closed position, the second end of the inlet pipe is in the open configuration (e.g., because a blind flange is not disposed over the second end of the inlet pipe, or the second valve is in the open position), and the second end of the outlet pipe is in the closed configuration (e.g., because the blind flange is disposed over the second end of the outlet pipe, or the third valve is in the closed position), then fluid flows from the first portion of the inlet pipe into the first portion of the n plates, then from the first portion of the n plates into the outlet pipe, then from the outlet pipe into the second portion of the n plates, and then from the second portion of the n plates into the second portion of the inlet pipe. Such a configuration permits the first and second chambers of the container (along with, respectively, the first and second portions of the n plates) to perform independently as individual thermal energy storage systems or sub-systems. “Independent” or “modular” operation of this type can be particularly useful if different PCMs are disposed in the first and second chambers of the container.

In some embodiments described herein, a first PCM is disposed in the first chamber, and a second PCM is disposed in the second chamber. The first PCM and the second PCM can be the same or differing PCMs (or combinations of PCMs) having the same or differing phase transition temperatures. For example, in some cases, the first PCM and the second PCM are differing phase change materials having differing phase transition temperatures. In some such implementations, the first PCM has a higher phase transition temperature than the second PCM. Alternatively, in other embodiments, the first PCM has a lower phase transition temperature than the second PCM, as described further herein. Each of the first and second PCMs can have any phase transition temperature, latent heat, composition, and/or other property described herein for PCMs. Moreover, the properties of the PCMs can be selected to provide a desired modularity or multifunctionality to the thermal energy storage system. In some cases, for instance, the first PCM has a phase transition temperature of 15-25° C., and the second PCM has a phase transition temperature of 4-8° C. Thus, in some embodiments, a thermal energy storage system described herein can be a “dual” system (or “dual-mode system”), which can be used for both heating and cooling applications, as described further below. Additionally, in some such instances, while one PCM is being used as a source (or drain) of latent heat, the other PCM can provide a source (or drain) of sensible heat.

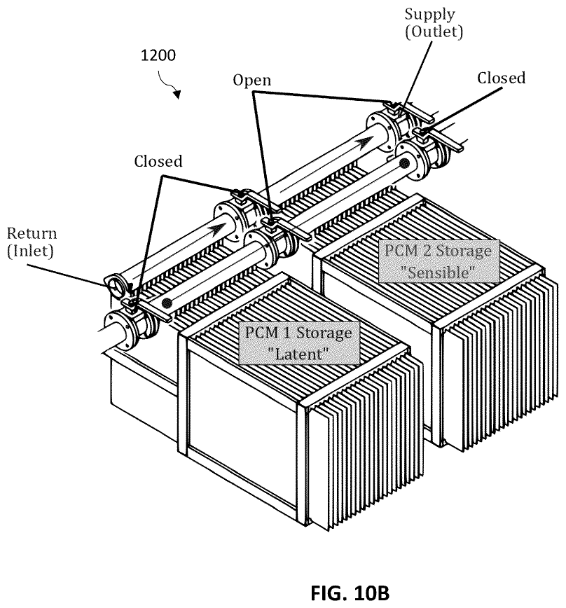

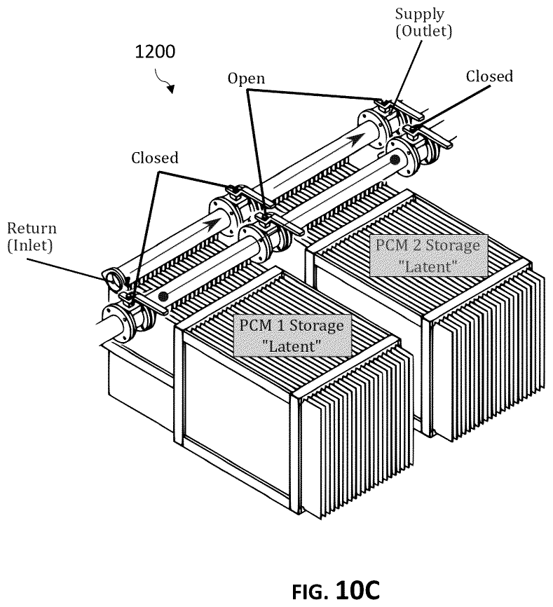

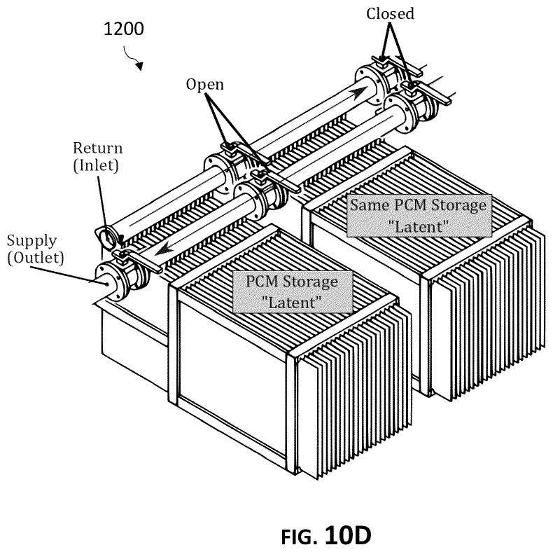

FIGS. 10A-0C represent embodiments of two different operation “modes” for various thermal energy storage systems described herein. In some of the shown embodiments, different PCMs are disposed in the first and second chambers of a thermal energy storage system, the system being combined with a manifold equipped with an interior valve dividing the inlet pipe into two portions (with two different streams/inlets and outlet). In FIG. 10A, the thermal energy storage system is subdivided into two regions to provide two independent “modes” in a split-parallel configuration. By closing both interior valves, the thermal energy storage system can operate as two independent sub-systems, which can carry out two distinct heat transfer processes simultaneously. In the exemplary embodiment shown in FIG. 10A, one of the independent sub-systems stores “hot” (or relatively high temperature) latent energy, while the other sub-system simultaneously stores “cold” (or relatively low temperature) latent energy. In FIGS. 10B and 10C, by opening one interior valve, the thermal energy storage system can provide two “stages” of heat transfer in series, such as a latent-sensible heat transfer in FIG. 10B and latent-latent heat transfer in FIG. 10C.

In the embodiment shown in FIG. 10D, the first and second chambers of the thermal energy storage system comprise the same PCM. When both interior valves are open, such that both sub-systems operate similarly, or in some cases nearly identically, the thermal energy storage system can provide a single stage and a single mode of either hot or cold latent energy.

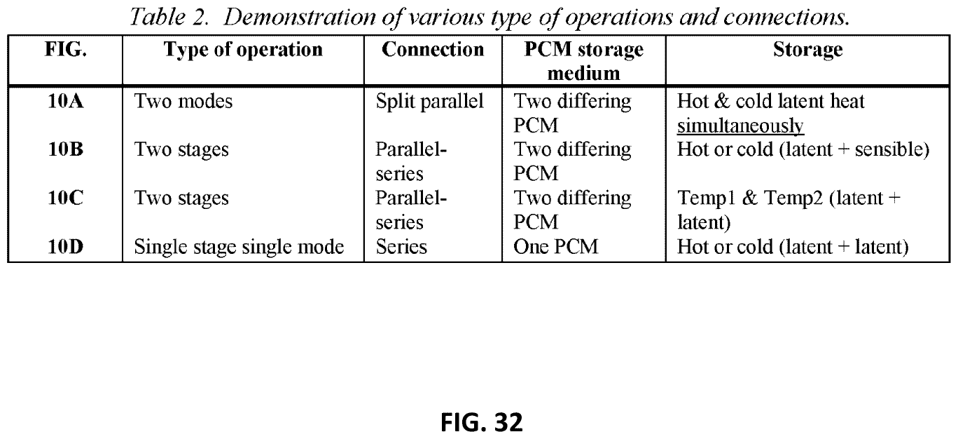

Table 2 of FIG. 32. Demonstration of various type of operations and connections.

Table 2 summarizes the three different operation modes shown in FIGS. 10A-10D. As demonstrated in Table 2, thermal energy storage systems described herein can be both modular and versatile, depending on the desired application.

It is further to be understood that “dual-chamber” or “split-chamber” embodiments are not necessarily limited to only two separate chambers containing two differing PCMs, supported by one interior valve in the inlet pipe dividing the inlet pipe into two portions.

Instead, as readily understood by one of ordinary skill in the art based on the present disclosure, the container of a thermal energy storage system described herein can be subdivided into any desired number of chambers to provide for any desired number of “stages” or“modes” of carrying out thermal energy storage and transfer (as opposed to providing only two “stages” or “modes.” Further, divider walls between such chambers can be aligned with respective additional valves in the inlet pipe, and the same or different PCMs can be disposed in the various chambers. In this manner, a thermal energy storage system described herein can be highly modular and highly versatile.

Moreover, it is also possible to obtain “staged” heating or cooling effects or multifunctional heat transfer by using a series of separate thermal energy storage systems described herein, instead of or in addition to using a single system having multiple chambers comprising multiple (differing) PCMs. For example, in some implementations, a thermal energy management system is described herein, the system comprising a first thermal energy storage system and a second thermal energy storage system, where both the first and second thermal energy storage systems comprise a thermal energy storage system described hereinabove. In some cases, the first energy storage system comprises a first container, a first heat exchanger disposed within the first container, and a first PCM disposed within the first container. The first heat exchanger comprises a first inlet pipe, a first outlet pipe, and a number n of first plates in fluid communication with the first inlet pipe and the first outlet pipe such that a fluid flowing from (or into) the first inlet pipe and to (or out of) the first outlet pipe flows through the first plates (or at least a portion or some of the first plates) in between the first inlet pipe and the first outlet pipe (or after flowing into the first inlet pipe but before flowing out of the first outlet pipe). Additionally, the first PCM is in thermal contact with the first plates. Similarly, the second thermal energy storage system can comprise a second container, a second heat exchanger disposed within the second container; and a second PCM disposed within the second container. The second heat exchanger comprises a second inlet pipe, a second outlet pipe, and a number m of second plates in fluid communication with the second inlet pipe and the second outlet pipe such that a fluid flowing from (or into) the second inlet pipe and to (or out of) the second outlet pipe flows through the second plates (or at least a portion or some of the second plates) in between the second inlet pipe and the second outlet pipe (or after flowing into the second inlet pipe but before flowing out of the second outlet pipe). The second PCM is in thermal contact with the second plates. Additionally, the number n and the number m are each at least 2.

Further, the first outlet pipe of the first energy storage system is connected to the second inlet pipe of the second energy storage system.

It is to be understood that such a series of thermal energy storage systems is not limited to only two systems connected in series. Any desired number of individual thermal energy storage systems described herein could be used or connected with one another.

Moreover, in some preferred embodiments in which multiple individual thermal energy storage systems described herein are connected with one another, the outlet of the nth system is connected to the inlet of the (n+1)th system using a straight pipe or connector, as opposed to a pipe or connector including an angle, bend, or elbow. Avoiding such turns or bends can help avoid undesired pressure differentials or pressure drops between individual systems.

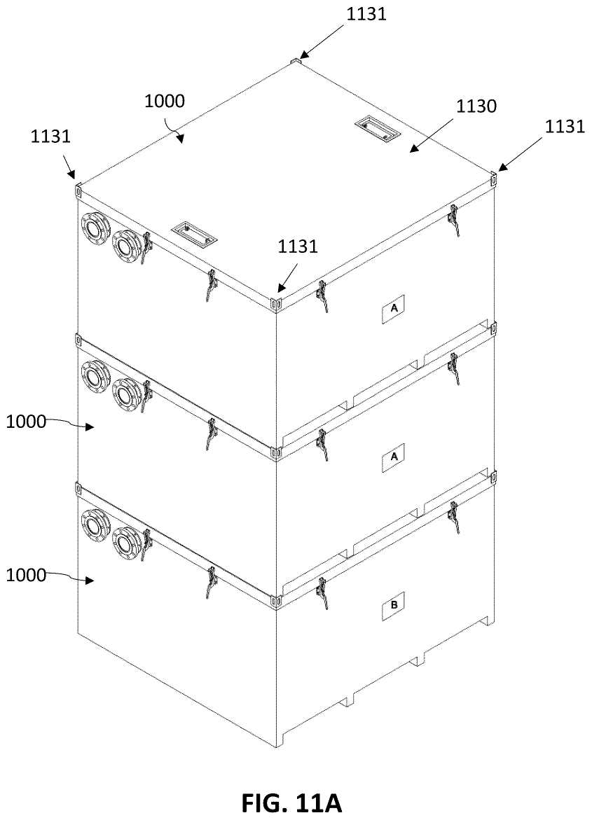

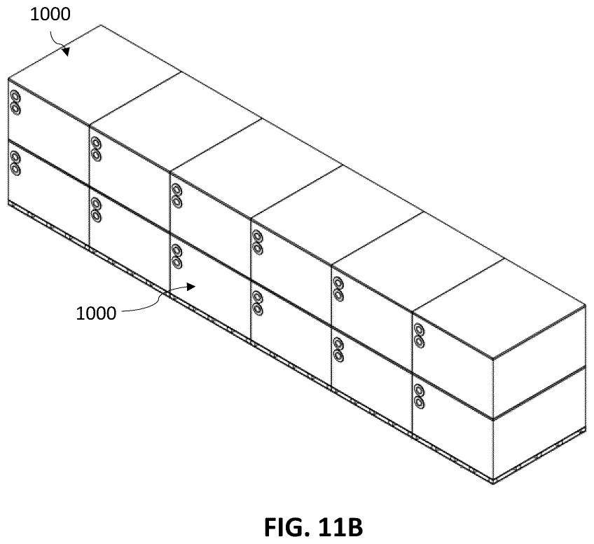

FIGS. 11A and 11B represent two non-limiting examples of a thermal energy management system described herein comprising multiple thermal energy storage systems connectable in series. For instance. FIG. 11A is an embodiment of n=3 individual thermal energy storage systems vertically stacked on each other, and FIG. 11B depicts an embodiment where =12 individual thermal energy storage systems (as a 6×2 stack or array). Such embodiments are merely exemplary and should not be interpreted as limiting.

The skilled artisan would appreciate that thermal energy management systems described herein can comprise n=2, 3, 4, 5, 6, 7, 8, 9, 10, 11, 12, 13, 14, 15, 16, 17, 18, 19, 20, or more than 20 individual thermal energy storage systems. It is further to be noted that, in some embodiments, the cover of an individual thermal energy storage system described herein can include one or more protrusions for receiving the bottom of a second thermal energy storage system stacked on top of the first thermal energy storage system. For example, as illustrated in FIG. 11A, the cover (1130) of the topmost system (1000) comprises four L-shaped brackets or protrusions (1131) that are attached to or integrally formed with the cover (1130) and that extend upwardly from the cover (1130) to provide a “lip” or other ridge or barrier for receiving the bottom of an additional system (not shown) which (in the example embodiment of FIG. 11A) might be placed on top of the stack of three individual systems to form a stack of four systems. The thermal energy storage systems below also include such brackets (1131) at the four corners of the systems' respective covers.

The depth of the “lip” or other ridge can be any distance desired to help secure or “nest” or “receive” the bottom of the system placed on top (e g., the depth from the top of the protrusion to the top of the cover may be 0.5-5 inches, 0.5-3 inches, 1-5 inches, or 1-3 inches). Moreover, fasteners other than the L-shaped brackets may also be used. For instance, one or more rods or sheet-shaped structures may be used if desired.

### II. Methods of Storing and Releasing Thermal Energy

In another aspect, methods of storing and releasing or otherwise managing thermal energy are described herein. In some implementations, such a method comprises attaching a thermal energy storage system described herein (or a thermal energy management system described herein) to an external source of an external fluid. The thermal energy storage system (or thermal energy management system) can be any thermal energy storage system (or thermal energy management system) described hereinabove in Section 1.

Moreover, as described further herein, the external fluid can be any external fluid not inconsistent with the objectives of the present disclosure. In some implementations, for instance, the fluid comprises a thermal fluid. For reference purposes herein, a thermal fluid can be a fluid having a high heat capacity. In some cases, a thermal fluid also exhibits high thermal conductivity. Moreover, the external fluid can be a liquid or a gas. A liquid fluid, in some embodiments, comprises a glycol, such as ethylene glycol, propylene glycol, and/or polyalkylene glycol. In some instances, a liquid fluid comprises liquid water or consists essentially of liquid water. A gaseous fluid, in some embodiments, comprises steam.

In addition, as described further herein, the external source of the external fluid can be any external source not inconsistent with the objectives of the present disclosure. In some preferred implementations, the external source of the external fluid is a source of heating or cooling, or a source of waste heat. In some cases, for instance, the external source of the external fluid comprises an HYAC chiller.

Methods described herein, in some embodiments, further comprise forcing a first portion of the external fluid through the heat exchanger of the thermal energy system. That is, the external fluid enters the heat exchanger through a proximal end and exits the heat exchanger through a distal end, having passed through the plates of the heat exchanger. Moreover, the first portion of the external fluid can enter the heat exchanger at a first or initial temperature (T1) and exit the heat exchanger at a second temperature (T2). Additionally, in some preferred embodiments, T1 and T2 are different. In some cases, T1 is higher than T2. Alternatively, in other instances, T1 is lower than T2.

It is further to be understood that, during the course of a method described herein, in some implementations, the first portion of the external fluid participates in thermal energy transfer or heat exchange with the PCM disposed in the container. For example, in some cases, the first portion of the external fluid transfers thermal energy or heat to the PCM, thereby lowering the temperature of the first portion of the external fluid. Additionally, in some such instances, the PCM stores at least a portion of the transferred thermal energy as latent heat (e.g., by undergoing a phase transition, such as a transition from a solid state to a liquid state).

Moreover, in some implementations, a method described herein further comprises forcing a second portion of the external fluid through the heat exchanger of the thermal energy system (e.g., at a later time), and transferring at least a portion of the stored latent heat from the PCM to the second portion of the external fluid, thereby increasing the temperature of the second portion of the external fluid.

In this manner, a thermal energy storage system described herein can store thermal energy during a first time interval and release it during a second time interval. For example, the system can store thermal energy when the PCM of the system is exposed to a relatively warm external fluid, where the relative warmth of the external fluid is based on the external fluid having a temperature that is greater than the relevant phase transition temperature of the PCM and greater than the temperature of the PCM. The system can release the stored thermal energy when the PCM of the system is later exposed to a relatively cool external fluid. Again, the relative coolness of the external fluid is based on the external fluid having a temperature that is lower than the temperature of the PCM at the time of thermal contact. Such a pattern of storing and releasing of thermal energy can be especially useful when it is desired to cool the external fluid during the first time interval. For instance, in some cases, the first fluid can be warm water associated with a chiller of an HVAC system or a fluid carrying “waste heat,” such as waste heat generated by or within a nuclear reactor cooling pool, or waste heat generated by steam released by an industrial process. It is to be understood that such cooling provided by a thermal energy storage system described herein can be considered to be “passive” cooling that does not require the input of energy from another source, such as a separate HVAC system or other cooling system. The thermal energy transferred to the PCM during such a passive cooling step can be considered to “discharge” or reduce the total thermal capacity of the mass of PCM disposed in the system. The thermal capacity of the PCM can be restored or “recharged” during the second time interval, when the heat transfer between the PCM and the external fluid proceeds in the opposite direction, as compared to when the initial cooling of the external fluid occurred. This “recharging” can be carried out, in some instances, when energy (e.g., obtained from the power grid and used to power a conventional HVAC system associated with the external fluid) is more abundant and/or less expensive, such as during “off peak” hours.

It is also possible for the storing-and-releasing cycle described above to be carried out in the opposite sequence—releasing of thermal energy (i.e., heating of the external fluid) followed by storing of thermal energy (i.e., cooling of the external fluid). Such a heat exchange cycle may be desirable when the thermal energy storage system is used to provide passive or “peak” heating, rather than cooling.

For example, in some implementations of a method described herein, the PCM transfers thermal energy or heat to the first portion of the external fluid, thereby increasing the temperature of the first portion of the external fluid. In such an instance, the PCM can transfer the thermal energy by discharging latent heat (e.g., by undergoing a phase transition, such as a transition from a liquid state to a solid state). Additionally, in some cases, the method further comprises forcing a second portion of the external fluid through the heat exchanger of the thermal energy system (e.g., at a later time period), and transferring thermal energy from the second portion of the external fluid to the PCM, thereby decreasing the temperature of the second portion of the external fluid.

Some embodiments described herein are further illustrated in the following Examples. It is generally to be understood that theoretical statements in the following Examples are not intended to bind the scope of the present invention.

### III. Examples

Many systems can benefit from the use of PCM heat exchangers for thermal energy storage in a manner described herein. One example is the heat removal system used in pool-type and small nuclear reactors. The main challenge is that the pool water temperature increases by 2° F. per 1 hour during operation. However, the cooling rate after shutdown is less than 2° F. per 48 hours. To remedy this, studies have been conducted using a sensible heat system utilizing chilled water/glycol tank in a loop to exchange heat with the reactor primary cooling system and cool 30,000 gallon of pool water from 88° F. to 68° F. in 1.5 hr. However, in order to extend the continuous operation of the reactor for longer periods at full power and to enable a reactor power upgrade in the future, it is required to have a higher cooling capacity than the limited sensible heat of water.

The use of PCM thermal energy storage systems described herein can overcome these limitations. Utilizing the latent heat of PCM can enable higher storage capacities in a smaller size and can be capable of targeting defined and constant discharge temperatures compared to sensible heat systems using water.

Another unique opportunity of PCM thermal energy storage is heat removal in data centers and server rooms. Temperatures in data centers and servers normally rise because of the heat generated by electronics and servers. In 2008, the American Society of Heating.

Refrigerating and Air-Conditioning Engineers' (“ASHRAE”) standards and thermal guidelines increased the maximum allowable operating temperature range of data centers and servers to 32° C. for class A1 server equipment, and recommended 27° C. as the average high-end temperature for all classes. This means that the data center thermal load can be met by the HVAC with a chiller water supply at a temperature of 22-24° C. The higher supply temperatures open new possibilities for the use of new smart strategies for load shifting purposes, such as utilizing the latent heat of PCMs with phase transition temperature of 18-19° C. in a storage vessel. For data centers, it becomes possible to produce 16-17° C. or lower water temperature from cooling towers to store “cold” energy in PCM during off-peak hours—at night—without mechanical chiller systems. The PCM storage vessel can be cooled during night hours using only efficient polymer fluid cooler (PFC) or cooling towers when the wet bulb temperatures are lower to produce water at 15-16° C., which is lower than the phase transition temperature of PCM. The frozen PCM that can be utilized later during the day during peak demand charges. In other scenarios when the supply temperature from PFC or the cooling tower at night is not low enough, the chilled water supply from the cooling tower may also pass to a small chiller as a secondary cooling stage to further reduce the water temperature before being utilized to freeze the PCM in the heat exchanger vessel. This process could occur at night when the electric rates and wet bulb temperature are low. During the day, the designed PCM storage heat exchanger should be able to meet the data center load without the need to run mechanical chillers. Previously, utilities and data centers have yet to implement such passive PCM latent heat storage systems that can be discharged at reduced demand charges without the need for mechanical systems, or at least, using much smaller chillers.

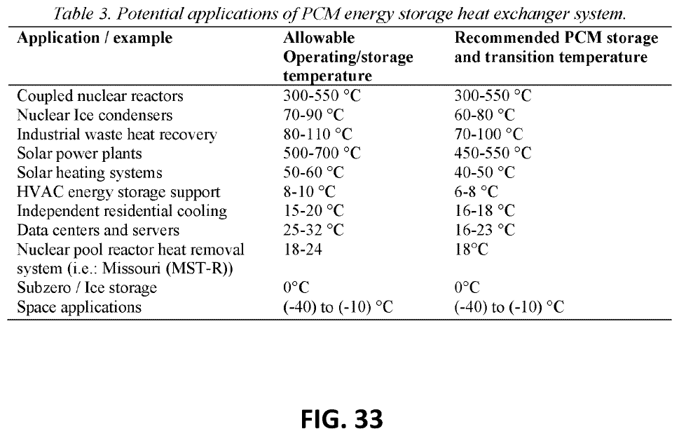

Table 3 of FIG. 33 shows the operating temperature and recommended PCM storage temperature of other applications that can utilize the PCMs in the form of a heat exchanger vessel.

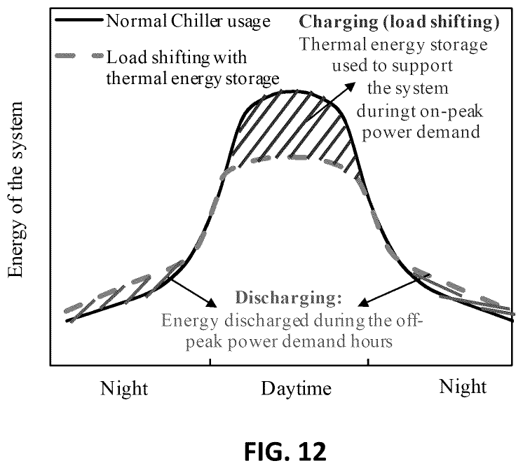

Ice storage has been used extensively for industrial applications and load shifting. The system consists of a tank in which circular or U-tubes are fully immersed in water. FIG. 12 shows an example of a typical load profile. The peak loading of any industrial system usually occurs during the day when the internal thermal load, temperatures and solar gain are higher. Existing conventional storage systems run chilled antifreeze in loop through the water thermal storage vessel at night—when power costs less—to freeze the water in a storage tank or vessel. Some advantages can be summarized as follows: (a) chillers are used during off-peak hours at night at low cost of electricity to store thermal energy in ice; (b) during the day, ice acts as a cold heat sink to store energy without the need to run chillers by simply exchanging heat with the return water loop that is coming from the primary heat source, (c) reducing the need to run chillers during on-peak hours and consumption is shifted to off-peak hours, thus reducing costs.

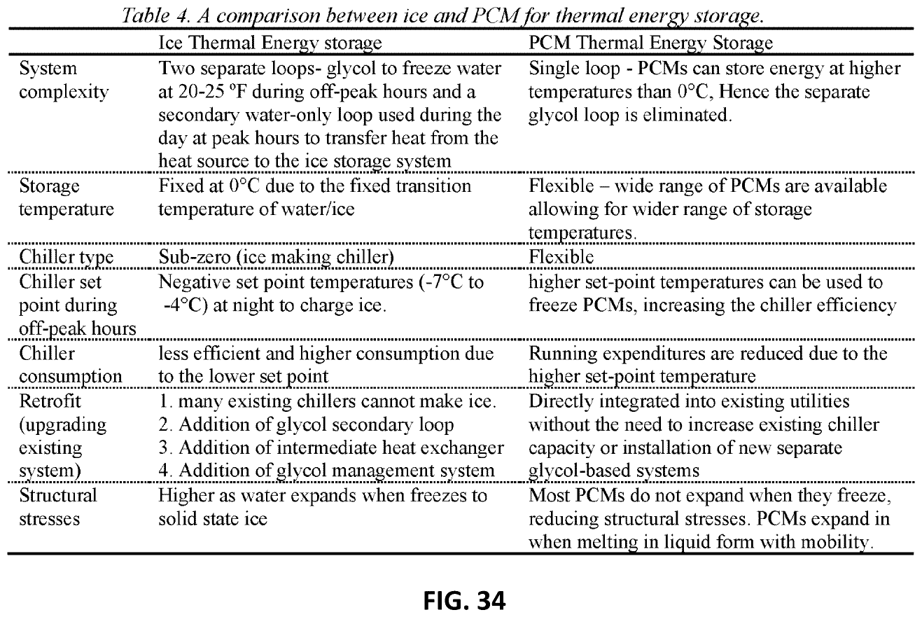

Ice thermal energy storage systems have been proven to be a cost-effective method, but some design limitations and challenges need to be solved. Table 4 of FIG. 34 lists some of the drawbacks of ice storage systems and show how PCM based thermal energy storage, such as described herein, can solve these issues.

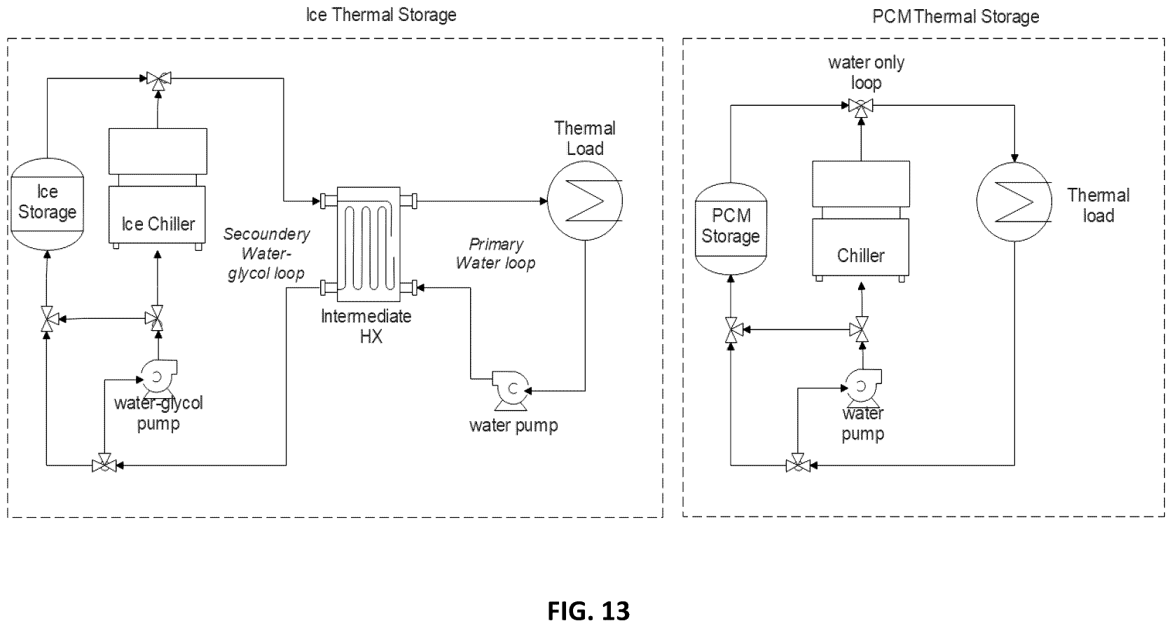

In summary, PCMs based storage systems not only can deliver energy cost savings, but also provide savings in infrastructure, equipment and therefore operational maintenance costs. A schematic comparison between the installation of proposed PCM energy storage systems and the conventional storage systems is given in FIG. 13.

Not intending to be bound by theory, it is believed that a major parameter affecting the performance of a thermal energy storage unit is the appropriate design of the heat exchange surface between the PCM and heat transfer fluid.

### Example 1: Thermal Energy Storage System

The following Example presents an exemplary design for a plate-type heat exchanger as a thermal energy storage unit/system utilizing PCMs. System performance was studied with respect to important experimental parameters such as the phase change front, self-shielding of PCM, uniform temperature distribution, effectiveness and performance trends as a function of various inlet conditions. Additionally, the exemplary design presents an alternative storage medium to simplify the design, enhance the efficiency of previous systems and to expand the range of traditional ice/chilled water installation strategies in some instances. Compared to some other systems, the current design can, in some cases, provide a novel and simpler solution by improving or removing certain design constraints of existing PCM and ice storage systems. In addition to a higher power output and high effectiveness values (>0.8) as a target performance, the advantages of the system described herein can include offering modular small units that can be easily transported and packaged with existing end uses. The modular units can optionally include a base on wheels and can be easily dismantled and transported in an elevator if needed at the end use location. Although not intended to be limiting, an exemplary PCM with a phase change transition temperature of around 18° C. was chosen for the energy storage system, which makes the system suitable for pool type reactors as well as data centers and server rooms, among other applications.

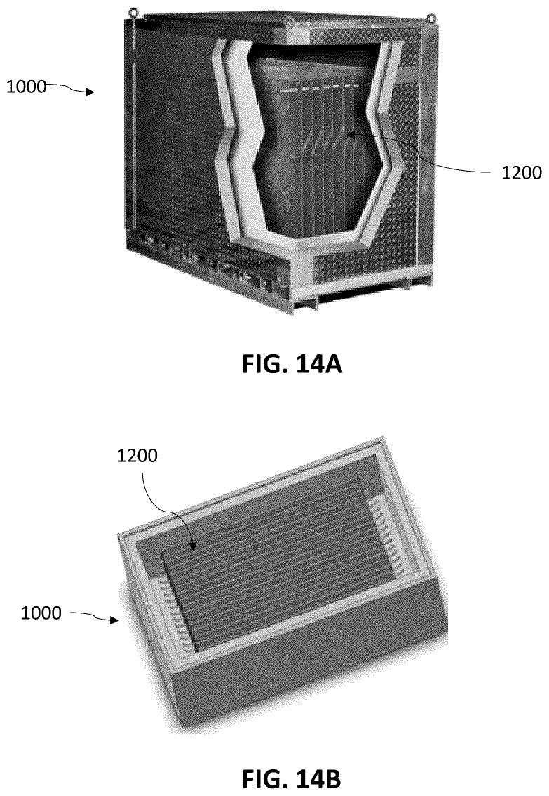

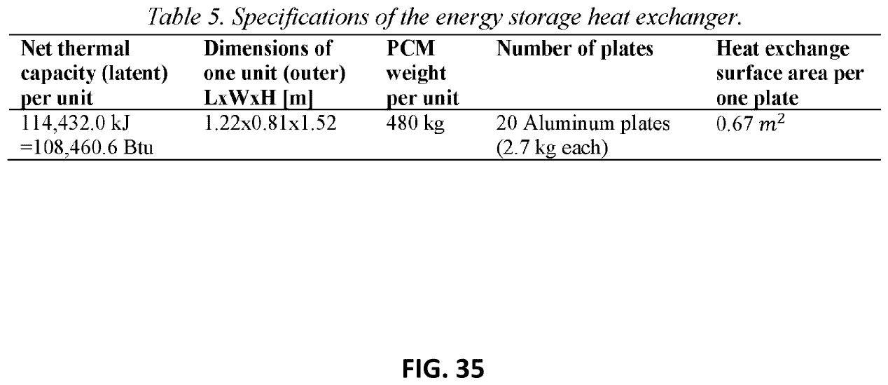

A heat exchanger unit was constructed from an insulated vessel of aluminum to hold the PCMs and heat exchanger plates of the heat transfer fluid. FIG. 14A is a perspective partial cutaway view of one unit of the heat exchanger and schematic of its components, and FIG. 14B is a top view of an interior receiving space having a plurality of heat exchanger plates embedded in PCMs. The specifications of the heat exchanger are given in Table 5 of FIG. 35.

Hexadecane was selected as the PCM for the heat exchanger, which has latent heat of 238.4 J/g equating to a total latent heat thermal capacity of 114,432.0 kJ or 108,460.6 Btu for a single heat exchanger unit. Due to the high latent heat capacity, a small footprint for the entire system was possible. The heat exchange plates were made from two overlaid sheet layers of aluminum to give a heat exchange surface of high thermal conductivity, commercially available as AHHM KLIMABOND METALLICO.

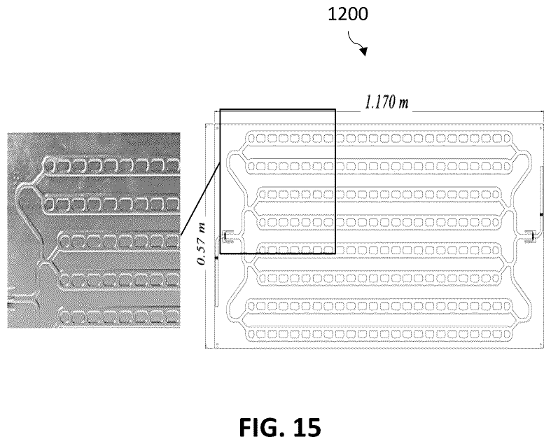

The two overlaid sheet layers house channels where the heat exchange fluid is circulated. The design of the channel helps to provide a uniform surface temperature, and to maximize heat transfer between the working fluid and PCM. The designed flexibility of the aluminum plates allows the unit to withstand the expansion and contraction of the PCM during solid-liquid phase transition. FIG. 15 shows a schematic of the heat exchange plates.

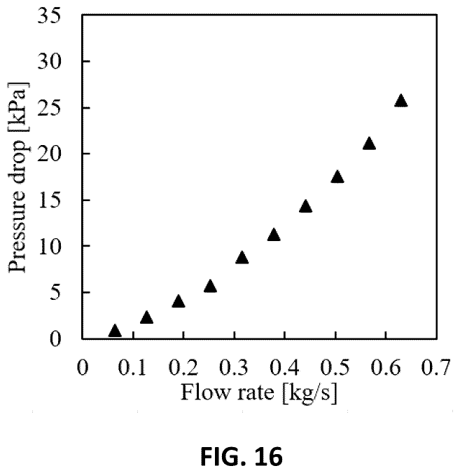

Leak (burst) and pressure drop tests were carried out using water as the heat exchange fluid at various mass flow rates. The maximum pressure resistance was found to be 600 kPa. The operating pressures for all experiments were lower than the burst pressure. The plates were connected to each other in parallel to achieve lower overall pressure drop and better heat transfer. A micro-bubble vent can be used to ensure proper circulation, prevent cavitation and reduce corrosion. FIG. 16 shows the pressure drop as a function of various mass flow rates across a bundle of 20 plates.

The impact of the plate spacing and heat transfer surface area was investigated by experiments.

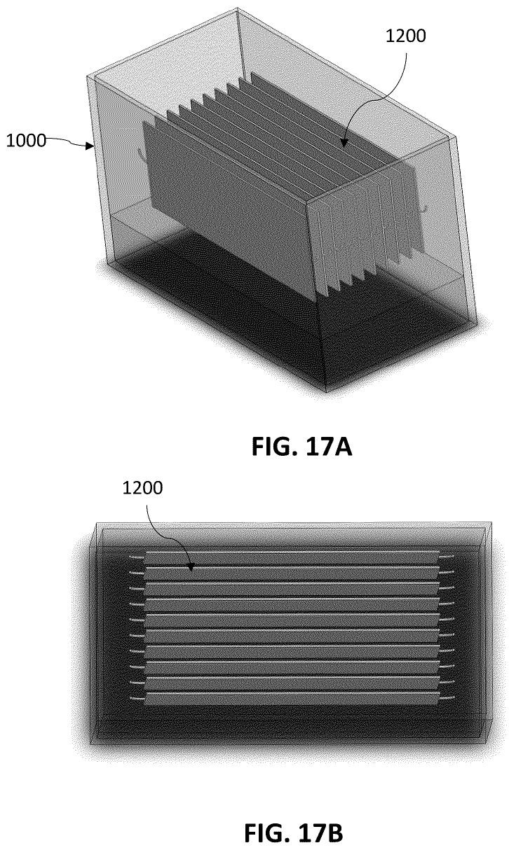

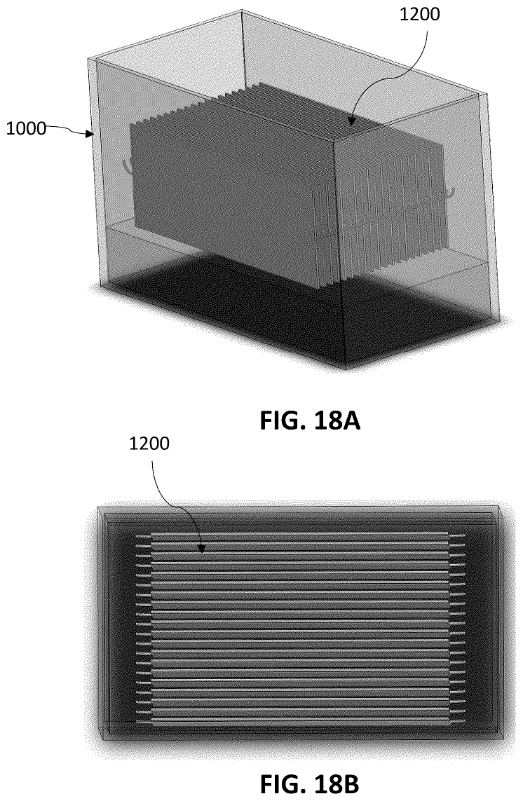

The plate spacing was tested at 1 inch (25.4 mm) and 2 in (50.8 mm), and the impact of spacing distance on the phase transition progress was measured visually and experimentally. FIGS. 17A and 17B heat exchanger plate spacing at 2 inches (50.8 mm) apart. FIGS. 18A and 18B heat exchanger plate spacing at 1 inch (25.4 mm) apart.

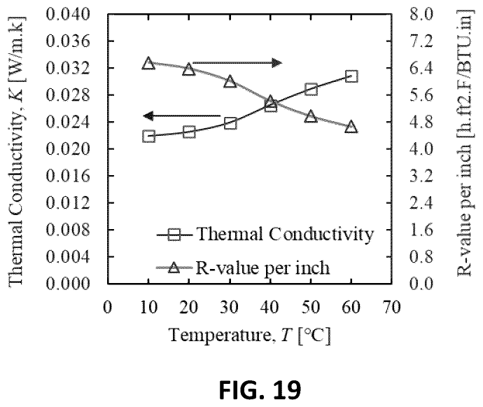

The outer walls of the heat exchanger vessel were made from aluminum sheets ⅛-inch thick and 1-inch thick aluminum supporting rods. An insulation of 2-inch thick polyisocyanurate foam was used on the interior walls of the heat exchanger vessel. A liner of vinyl was then applied as a barrier between the insulation walls and the PCM to avoid any leakage. The polyisocyanurate insulation was in compliance with ASTM C1289-17 standards for Faced Rigid Cellular Polyisocyanurate, and ASTM E2357 as a component of an air barrier assembly. The insulation is capable to handle temperatures between −40 and 93° C. The R-value of the polyisocyanurate insulation was measured using the FOX314 TA instrument as a heat flow apparatus by establishing a steady state 1-D heat flux through a 12×12 inch insulation sample between two parallel plates. Four optical encoders were used to control the position of plates and to establish a full contact with the sample. FIG. 19 gives the measured thermal conductivities and R-values at (10, 20, 30, 40, 50, and 60° C.) for the heat exchanger vessel.

The temperature of the inlet and exit fluid were measured using a S-TMB-M002 smart temperature sensors to an accuracy of +0.2° C. The locations of the sensors were fixed just before the inlet/exit of the plates and above the PCM level. The fluid flow velocity was measured by Dynasonics DXNP-ABS-NN ultrasonic flow meter with an accuracy of 0.03 m/s. In addition to this, GPI™ series water flow meters with a measurement accuracy of +3% were installed on the inlet and outlet pipes of the PCM heat exchanger for redundancy.

### Example 2: Experimental Facility with A Thermal Energy Storage System

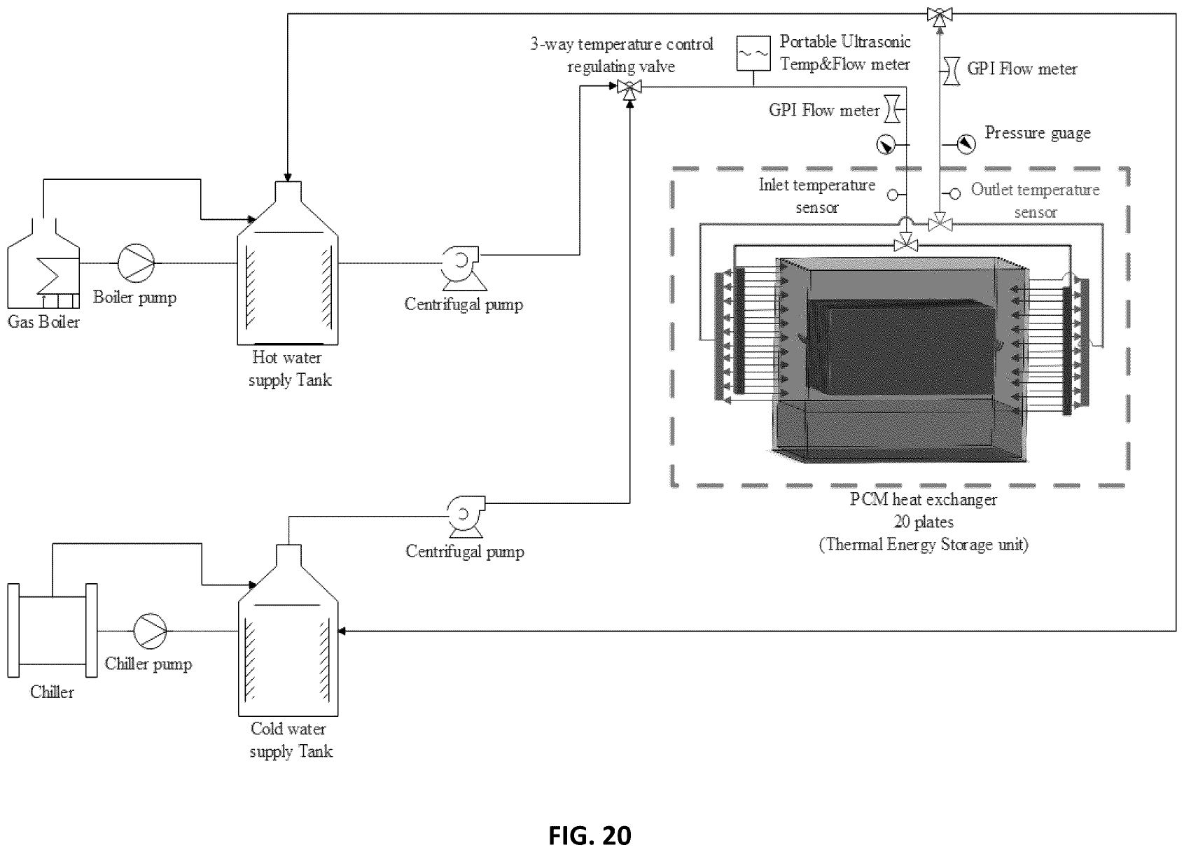

An experimental facility was built using the thermal energy storage system described in Example 1. FIG. 20 is a schematic of the experimental facility. Water is held in two tanks with combined volume of 7.6 m³ (2000 gallon), one tank as a source for chilled water and one for hot water. Two pumps of 2 horsepower were used to circulate water from the hot and cold loops to the PCM heat exchanger.

A 1.5″ Belimo G340+SVB24-SR mixing valve coupled to Honeywell T775M2006 controller with proportional 4-20 mA output was used to provide temperature feedback. This temperature feedback was used to control the valve position and achieve sufficiently uniform flow by mixing two water inlets, one from the hot source tank and one from cold source tank, at the desired temperature set point. In other cases, based on the required inlet temperature, only one loop was utilized. The cold loop utilizes a 34.4 kW refrigeration chiller (Temptek CFD-IOA) connected to a chilled water storage tank. The hot water loop includes a hot water storage tank attached to a 114 kW Hayward H400FDN boiler.

Pressure gauges with an accuracy of +1 kPa were used to measure the pressure drop across the plates assembly. All the supply and return pipes, including the chiller and boiler side pipes, were 1.5″ PVC pipes. Check valves were used to prevent the back flow of water into the storage tanks. The pipes between the heat exchanger and the mixing valve were insulated to minimize heat loss/gain from the environment. The set temperature of the Honeywell temperature controller was manually calibrated to supply water at the desired temperature at the inlet of the heat exchanger.

The Number of Transfer Units (NTU) decreases with time for plate heat exchanger, assuming that phase change process takes place in the direction of flow. Therefore, the inlet was designed to accommodate a counter flow condition in adjacent plates, thus enhancing the effectiveness of the heat exchanger.

### Example 3: Performance of Experimental Facility with a Thermal Energy Storage System

Performance of the experimental facility described in Example 2 was determined as follows. During charging (melting) tests, water at inlet temperatures of (75, 85, and 95° F.) was circulated through the channels of the heat exchange plates at various mass flow rates (0.126, 0.252, 0.378 kg/s) for each inlet temperature. Prior to each charging experiment, the PCMs were pre-conditioned (frozen) at around 55-60° F.

During discharging (cooling) experiment, water inlet temperatures of (55, 50, and 45° F.) was circulated for discharging. For discharging, it can be beneficial to discharge at an inlet temperature that is as high as reasonably possible as the chiller is more efficient at higher temperatures. In some cases, the discharge of the vessel can advantageously be as short as possible during off-peak hours. Here, only the highest mass flow rate of 0.378 kg/s was used for energy discharge at various inlet temperatures. Prior to each discharging experiment the PCMs were melted and staged at around 75° F.

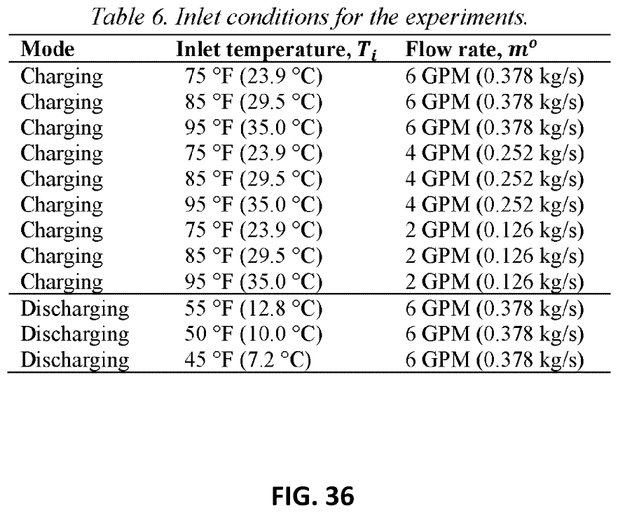

The test conditions for the experiments are illustrated in Table 6 of FIG. 36, where the various inlet temperatures (71) and mass flow rates (m°) are given for several charging and discharging tests.

The total energy stored by the heat transfer fluid can be obtained by considering the temperature variation across the heat exchanger vessel as given in equation 1 of FIG. 41 for the rate of energy storage (q′), and equation 2 of FIG. 42 for cumulative energy storage (Q), where m° is the mass flow rate of water, 71 is the temperature inlet, T₀ is the temperature outlet, Cp is the specific heat of the heat transfer fluid, and I is the time.

In physical terms, the heat exchanger effectiveness can be defined as the ratio of actual heat transferred to the theoretically maximum possible heat transfer between the two sides of heat exchanger. Effectiveness-number of transfer units NTU (e-NTU) technique is a method of characterizing the performance of a heat exchanger. A simplified mathematical model based on the e-NTU technique has been reported, with equations 3 (FIG. 43), 4 (FIG. 44), and 5 (FIG. 45) summarizing the effectiveness model considered for the analysis of the heat exchanger. Equation 3 gives the instantaneous effectiveness (e) at any time during the experiment at a given Tₒ and T whereas equation 4 gives the averaged effectiveness (e) of the heat exchanger during the PCM phase transition time (t₂-ti) during which the latent heat shoulder is observed in the leaving water temperature-time curve. Equation 5 accounts for NTU between the PCM and the heat transfer fluid, where the NTU is a dimensionless parameter that is defined by the ratio of the product of overall heat transfer coefficient (U) and the contact surface area to the heat capacity rate of the transfer fluid (water) as given in equation 6 of FIG. 46. It is to be noted that a more general definition of NTU can be given by equation 7 of FIG. 47, where Cₘᵢₙ is the minimum heat capacity rate of the two fluids.

As in the design relevant to this Example, the value of Cₘᵢₙ is the amount of heat the system can absorb per unit temperature change. The PCM in general in its liquid or solid state has lower heat capacity than the working fluid. However, since the PCM undergoes no temperature change during latent heat exchange, it has infinite heat capacity (per unit temperature) at that time and the minimum heat capacity rate should be that of the working fluid. Similarly, studies have suggested that one can use the specific heat of heat transfer fluid to get an estimate of effectiveness of a thermal energy storage heat exchanger. In the present disclosure, however, equation 3 was used to calculate the instantaneous effectiveness. The integration was performed as given in equation 4 using the trapezoidal rule and averaged over the period of a complete phase transition.

Despite the fact that the energy storage vessel is well insulated, some energy loss or gain from/to the environment may exist due to the thermal bridges and design deficiencies. The physical significance of energy efficiency given in equation 8 of FIG. 48 is to compare the total amount of available energy storage in the PCM to the amount of energy stored in the PCM.

Where PCM is the mass of PCM in the heat exchanger, H_{DSC} is the enthalpy of the PCM as experimentally measured using the DSC method in J/g, T is the phase transition temperature of the PCM, Tᵢₙᵢₜᵢₐₗ is the initial temperature of the PCM in the heat exchanger when the experiment starts.

### Example 4: Phase Change Material

Phase change materials (PCMs) other than ice have been extensively studied in many applications. Because of their attractive features, organic PCMs such as fatty acids and paraffin are of special note. The long-term thermal stability, high latent heat, non-corrosiveness and ability to make new eutectic mixtures are some advantages of organic PCMs. For an efficient thermal energy storage system, the phase transition temperature can be as close as reasonably possible to the temperature range at which the system needs to be maintained. Some criteria of selection for PCMs are given below:
1. Higher latent heat capacity, to increase the amount of energy storage for a given volume.
2. Long-term thermal stability.
3. Small volume changes during solid-liquid transition, to reduce pressure and stresses on the heat exchanger components during contraction and expansion. While ice expands during solidification, PCMs tend to shrink during solidification and expand only during melting which results in much less stresses because of the mobility of liquid PCM during expansion compared to solid ice during expansion.
4. Non-corrosiveness and non-toxicity.
5. Availability and cost of the PCM.

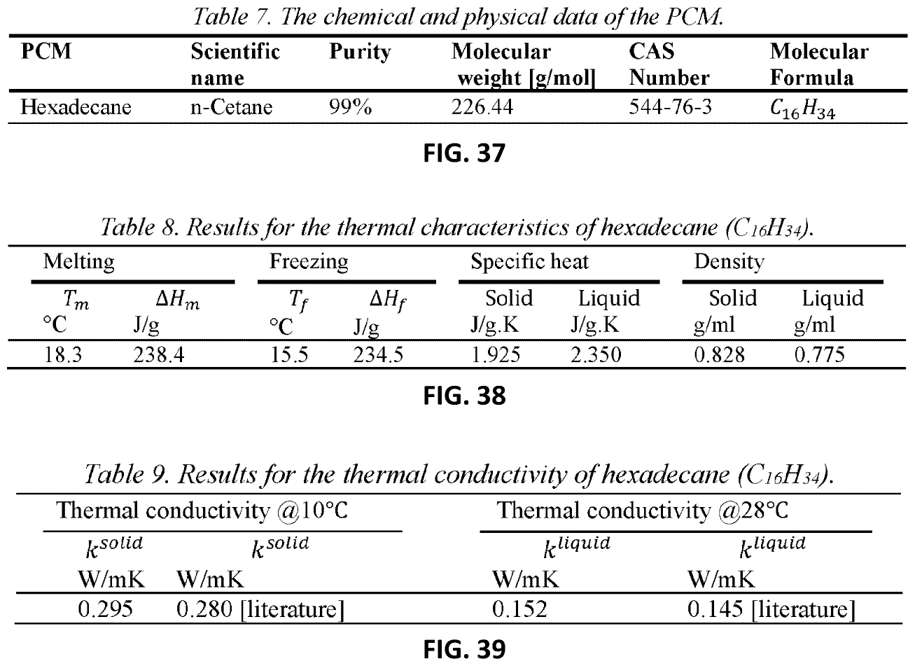

A paraffin PCM, hexadecane (C16H34), with transition temperature of 18° C. was chosen to analyze the energy storage heat exchanger. Hexadecane is a linear-alkane hydrocarbon paraffin consisting of chain of 16 carbon atoms and 34 hydrogen atoms. The PCM was supplied by Sigma-Aldrich with 99% purity. The chemical and physical data are given in Table 7 of FIG. 37.

Differential scanning calorimetry measurements were carried out using a modulated DSC (Discovery M-DSC, TA instruments). The aluminum DSC pans are (TA Tzero Pans #901683.901, and Lids #901684.901). All the samples were sealed using a standard press kit (Tzero #901600.901). DSC measurements were performed using a sample mass of 7-8 mg sample mass and heating rate of 3° C./min per recommendations for high accuracy 126, 271 The DSC calorimetric precision, temperature accuracy and baseline noise are ±0.04%, ±0.025° C. and <0.08 pW respectively. A two-stage refrigeration system (TA-RCS90) was coupled with the DSC to control the temperature ramp during the freezing cycle.

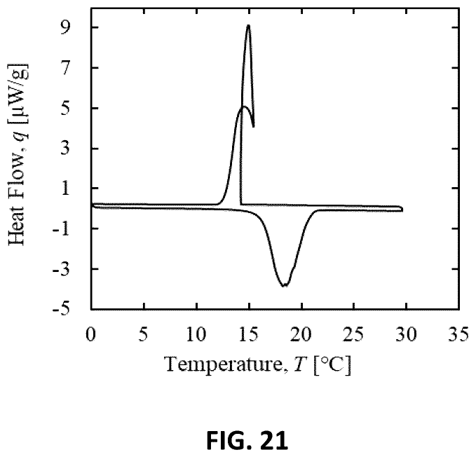

Five DSC measurements were performed on hexadecane, and the averages are reported here. FIG. 21 shows the melting and freezing phase transition of hexadecane. The phase transition temperature is an important property to consider as it determines the temperature at which the energy can be charged or discharged. A summary for thermal characteristics of hexadecane is given in Table 8 of FIG. 38. The behavior of the freezing phase transition is of interest. The DSC profiles in FIG. 21 reveal a great deal of information regarding the crystallization of the PCM. For some other PCMs, the exothermic peak continues to raise with somewhat decrease in temperature responding to the cooling rate demand of the DSC cell. The crystallization rate for the measured PCM, however, was so fast that the DSC scanning rate was relatively too slow to cool the PCM temperature further to lower temperature. This is indicated by the increase in temperature from 15.06° C. peak temperature to 15.45° C. before it continues to decrease to lower temperatures.

There is some time required for the crystallization of PCM to develop, in this case the rate of crystallization was relatively fast compared to some other PCMs. The hexadecane PCM exhibited a latent heat capacity of 238.4 J/g for melting and 234.5 J/g for freezing. The specific heat and density for the solid (10° C.) and liquid (28° C.) phases of PCM are given in Table 9 of FIG. 39. The experimental DSC results were found to be in a good agreement with the reported values in other studies, except for the freezing phase transition data. This may be attributed to the higher resolution (0.005° C.) of the advanced M-DSC used in this study which revealed more detailed information on the liquid to solid crystallization rate and behavior. Thermal conductivity (k) was measured using the heat flux meter (Fox314, TA instrument). The measurements were conducted in accordance with ASTM 1784 (Standard Test Method for Steady-State Thermal Transmission Properties by Means of the Heat Flow Meter Apparatus) and ISO 8301. The thermal conductivity was found to be 0.152 W/mK for the solid state at 10° C. and 0.295 W/m·K for the liquid state. These values are in good agreement with literature values as shown in the comparison given in Table 9.

### Example 5: Effect of Plate Spacing on Heat Exchanger

Due to the flexibility of the storage temperature which can be controlled based on the used PCM, the design was characterized as a function of absolute temperature differences relative to the PCM transition temperature at various inlet conditions. This provides insights into the scalability and performance of the system at differing design temperatures by only varying the phase transition of PCM to account for different applications at higher or lower temperatures.

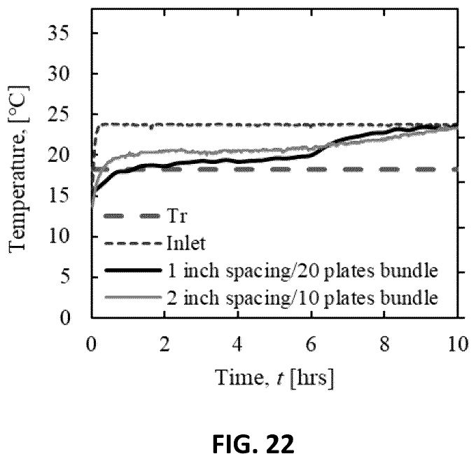

With the low thermal conductivity of the PCM medium, the plate-plate spacing is an important parameter for heat exchangers described in at least Examples 1 and 2 herein. FIG. 22 shows the temperature-time curve for two experiments of different plate-plate spacings, 1 inch and 2 inches. During these experiments, the inlet temperature was fixed at 23.9° C. As shown in FIG. 22, Tᵣ represents the transition temperature of the PCM (18.3° C.) while the two solid lines show the outlet water temperature for two different plate-plate spacing. For the 2-inch plate-plate spacing a bundle of 10 plates was loaded in the heat exchanger, whereas a bundle of 20 plates was used for the 1-inch plate-plate spacing. The total flow rate across the heat exchanger was kept equal for both arrangements. The experiment performed with 1-inch plate-plate spacing showed a higher temperature difference between inlet and outlet, lower exit water temperature and a more pronounced transition shoulder meaning that effectiveness is higher. In addition, the latent heat energy storage was completed in shorter time meaning that the rate of energy storage is higher. Despite that the total mass flow rate across the whole bundle is the same for both arrangements, the mass flow rate per plate however is less for the bundle of 1-inch plate-plate spacing when compared to that of 2-inch plate-plate spacing this is because the total mass flow rate is divided over larger number of plates. Therefore, the heat transfer fluid takes longer time of heat exchange with the PCM. It can be concluded that the 1-inch plate-plate spacing arrangement showed better performance, hence this preferred arrangement was considered for further analysis. Increasing the packing density of plates can impact the energy density and reduce the available volume for PCM. However, due to the small thickness of plates, the volume taken by a bundle of 10 plates and 20 plates is only 1.3% and 2.6% respectively.

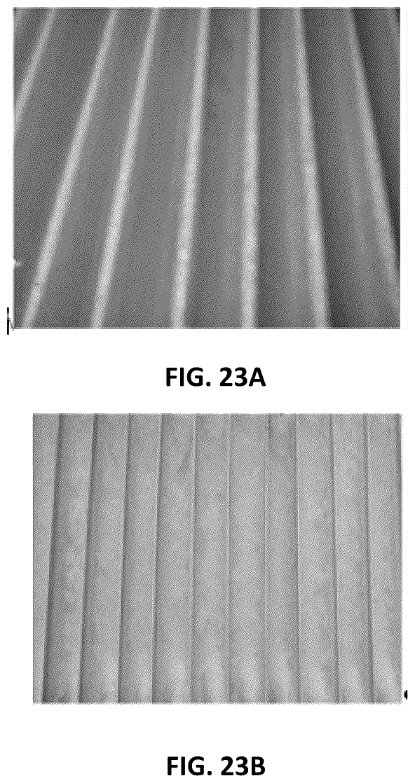

FIGS. 23A and 23B show another relevant observation. During the pre-discharge (freezing) phase, the PCM closer to the surface of plates experienced an increased freezing rate compared to the PCM in between the plates as shown in FIG. 23A for the 2-inch plate-plate spacing. Therefore, forming a thin film of frozen PCM layer at the surface of plates sooner than the PCM at the center in between plates. This was remedied upon reducing the plate-plate spacing to 1-inch which resulted in a lower temperature gradient between the plates and shorter freezing time difference between the PCM close to the plates and PCM in between as shown in FIG. 23B. Specifically, FIG. 23A shows a thin film of PCM layer at the surface of plates during a discharge cycle using 2-inch plate spacing, and FIG. 23B shows the thin film of PCM layer after complete discharged (frozen) PCM using 1-inch plate spacing.

### Example 6: Thermal Energy Storage Performance of Heat Exchanger

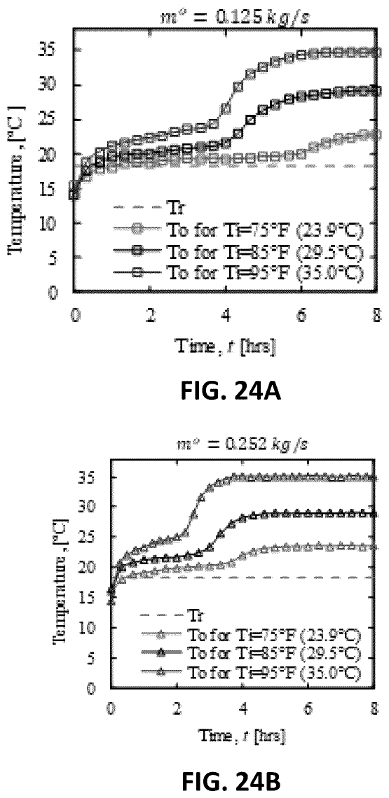

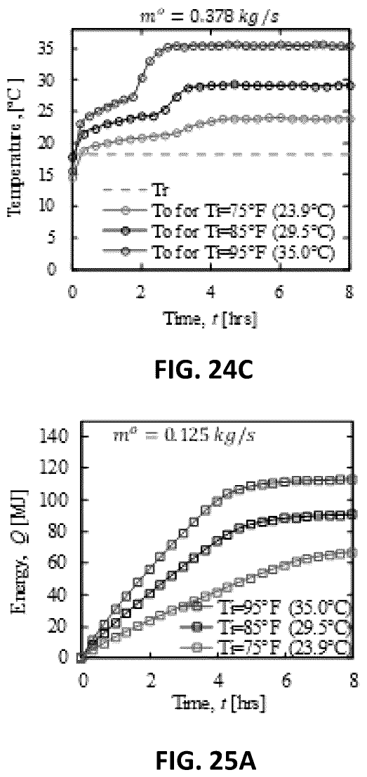

FIGS. 24A-24C compares various outlet water temperature profiles with respect to time during the melting tests at various flow rates and inlet water temperatures for heat exchangers described in Examples 1 and 2 herein. The general behavior of the outlet temperature profiles asymptotes to the inlet temperature marking the steady state achieved after end of melting process and sensible heat region. At higher flow rates or higher inlet temperatures this steady state is achieved more quickly, representing a higher charging rate.

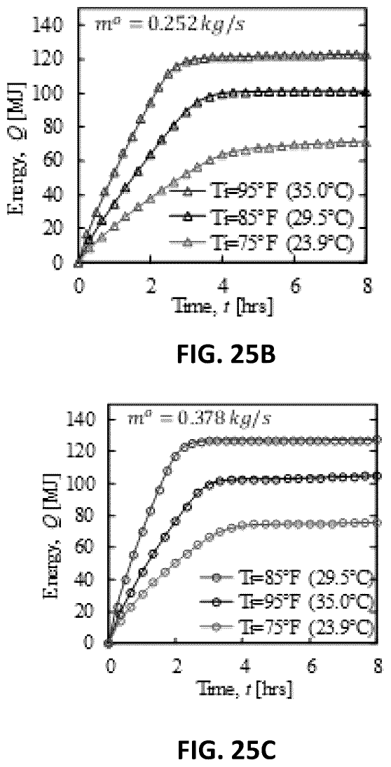

The profiles for the cumulative energy stored in the PCM heat exchanger at various inlet temperatures and mass flow rates are given in FIGS. 25A-25C. As the time increases, rate of heat transfer to PCM decreases and the cumulative energy value saturates with the maximum amount of energy that the system can store.

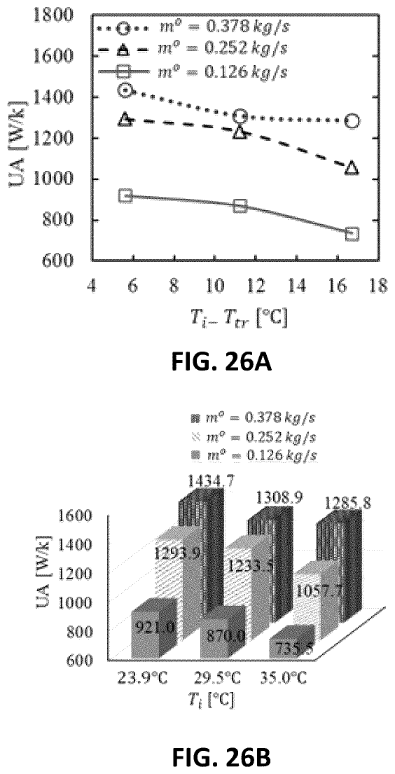

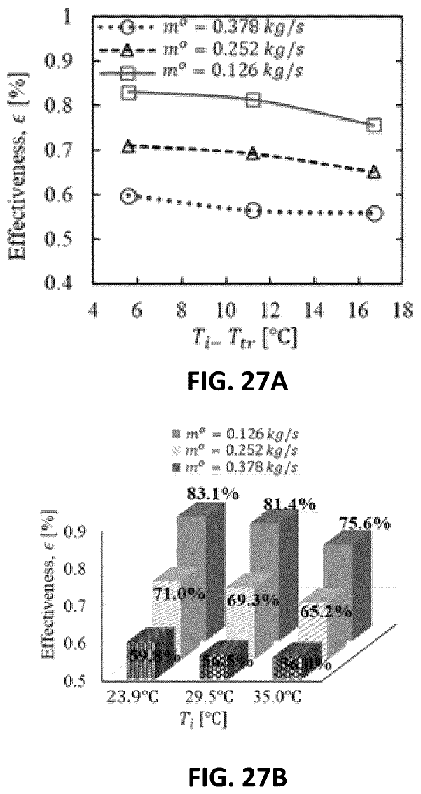

FIGS. 26A and 27B show several trends. For the experiments at higher inlet temperatures at the same flow rate, the overall heat transfer coefficient (U) tends to slightly decrease. This may be due to localized phase change conditions around the plates. The PCM layer next to the heat exchanger plates—the phase change front—melts sooner than the PCM further away from the plates, and a thin film of PCM layer forms at the surface of the plates. This results in a fully-charged melted PCM film that acts as an insulation layer of low thermal conductivity (0.152 W/m·K) which is 48% lower than the uncharged solid PCM (0.295 W/mK). This layer is known as the phase change front whereas the phenomenon is known as self shielding of PCMs. This is similar in concept to the formation of solid/frozen layer of PCM during the discharge/freeze cycle that is most readily observed at larger plate-plate spacings as previously shown in FIGS. 23A and 23B. However, the decrease in the overall heat transfer coefficient in FIGS. 26A and 26B is not supported by the trends seen in FIGS. 25A-25C. FIGS. 25A-25C indicate that as the inlet temperature increases, the total energy stored tend to increase. At first glance, it might appear that the decrease of energy storage in FIGS. 23A and 23B as the inlet temperature decreases is counter-intuitive because the values of overall heat transfer coefficient tends to increase for lower inlet temperatures. However, while not intending to be bound by theory in this Example (in general and in this instance), it is believed that the energy storage gain from sensible heat for the higher inlet temperature outweighs the effect of lower heat transfer coefficient. Additionally, for lower inlet temperatures the charging period becomes longer as seen in FIGS. 24A-24C, which may result in a higher heat leakage between the PCM in the heat exchanger and the environment due to the longer experimental time, thus reducing the available storage energy for the fluid for the experiments of lower inlet temperatures.

FIGS. 27A and 27B presents the effectiveness profiles of the PCM heat exchanger of Examples 1 and 2 at various inlet conditions. For lower inlet temperatures, the effectiveness of the heat exchanger is higher, meaning that the leaving water temperature (Tₒ) is relatively closer the phase transition temperature (TV). However, the cumulative energy storage is less for lower inlet temperatures as discussed above. Similarly, the effectiveness of the heat exchanger is higher for lower flow rates. This trend is also carried through the average leaving water temperature in FIGS. 24A-24C, where the difference between Tₒ and Tᵣ is lowest for lower mass flow rates due to the higher effectiveness. It can be said that the measured effectiveness is within an excellent range for a heat exchanger when the secondary side—PCM in this case—is stationary. At a mass flow rate of 0.126 kg/s per one heat exchanger unit and Ti-Tᵣ<10° C., the effectiveness can be better than 82%. This effectiveness compares well when compared with conventional heat exchangers utilizing PCM for thermal energy storage which have a maximum effectiveness of 0.68-0.75 for a tube in PCM arrangement, less than 0.67 for PCM encapsulated in plates arrangement, and 0.5-0.7 for PCM and gas direct contact arrangement.

It can be concluded that an effectiveness of more than 80% was possible even when the fluid inlet temperature was 10° C. higher than the phase transition temperature of PCM. As the effectiveness somewhat decreases with increasing mass flow rate, the effectiveness can still be maintained at >80% by fixing the mass flow rate per unit and increasing the number of heat exchanger units by installing them in parallel. For instance, 20 heat exchanger units can be connected in parallel each at 0.252 kg/s per unit giving a total mass flow rate of 5.04 kg/s for the entire system at any inlet temperature of Ti-Tᵣ<10° C. to maintain an effectiveness of 70% or higher.

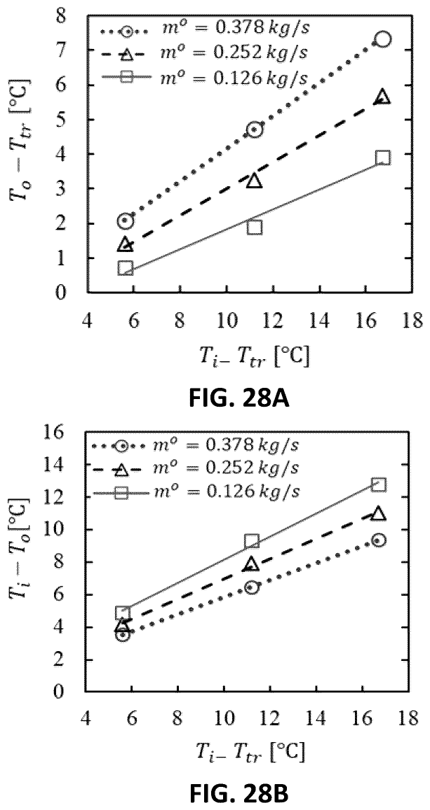

Again not intending to be bound by theory, it was noted that the effect of varying the mass flow rate on the cumulative energy storage is much less determinative when compared to that of the inlet fluid temperature as shown in FIGS. 25A-25C. A trend of a very slight increase in the cumulative energy storage was observed for the experiments of higher mass flow rates for the same inlet temperatures. This may be due to the higher overall heat transfer coefficients and shorter experimental time during which the charging process was completed for the higher mass flow rates at the same inlet temperature. As previously discussed, the shorter experimental time for heat leakage resulted in less“cold energy” loss, whereas the higher overall heat transfer coefficient helps in utilizing more PCMs far away from the plates. For these reasons, a trend of somewhat higher cumulative energy storage is observed for the experiments at higher flow rates and same inlet. Whereas the lower effectiveness at higher flow rates as shown in FIGS. 25A-25C may result in larger deviations between leaving water temperature and the phase transition temperature, a different PCM with lower phase change temperature can be utilized to achieve the same high cumulative energy storage at high flow rates as well as relatively lower leaving water temperature as required by the end user's or the thermal load system. For that reason, the performance of a PCM heat exchanger can be described with respect to the difference between To and Tr (To-Ttr) as a function of (Tt-Ttr) and mass flow rate (m°). This trend is shown in FIGS. 28A and 28B. The leaving water temperature follows a linear trend with increase in inlet water temperature. This can be extrapolated to suit the actual operating conditions.

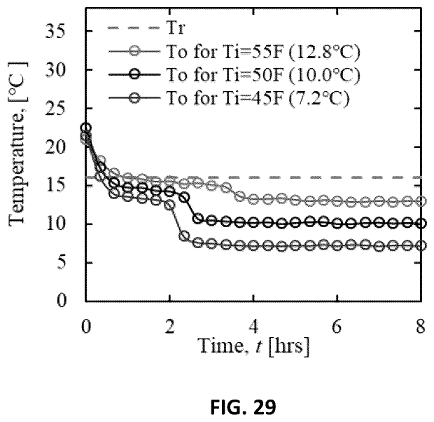

FIG. 29 is a graph of discharge (freezing) profiles for various inlet conditions for the PCM heat exchanger of Examples 1 and 2. The discharge time is a relevant parameter to consider along with the discharging inlet temperature, as it is important in determining the rate at which energy can be extracted. In general, a short discharge time can reduce the time at which the chiller will be running during the off-peak hours. In addition, the inlet temperature during the discharge (freezing the PCM during off-peak hours) can be high, in some cases if desired, because chillers are more efficient at higher temperatures, thus reducing cost and energy consumption. Here, only a high mass flow rate (0.378 kg/s) was used for all the discharging experiments at various discharge inlet temperatures of (12.8° C., 10° C. and 7.2° C.).

The freezing temperature-time curves of FIG. 29 show some trends. First, the discharge profiles showed a reasonably shorter latent heat period when compared to the charging profiles of the same mass flow rate (0.3785 kg/s) and (T-Tᵣ) temperature differences (i.e. Ttr-Ti=5.5° C. for discharge, and /)−/,=5.6° C. for charge). As previously discussed, during a discharge process the PCM next to the heat exchanger plates will solidify, forming a thin film of PCM layer that is 94% higher in thermal conductivity. This is in contrast to the self-shielding effect during the charging process. Second, the temperature-time curves in FIG. 29 for all the discharge process are somewhat more pronounced in the region of phase transition latent heat when compared to that for the charging curves in FIGS. 24A-24C, in part due to the narrower liquid to solid phase transition peak as supported by the differential calorimetric measurements (FIG. 21), and in part due to the higher thermal conductivity and thermal diffusivity for the solid PCM during liquid to solid phase transition which results in lower temperature gradient.

### Example 7: Parametric Analysis of Heat Exchanger

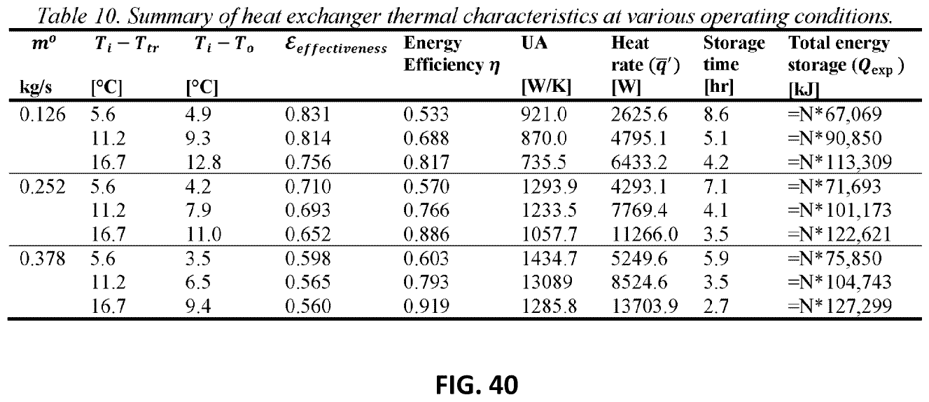

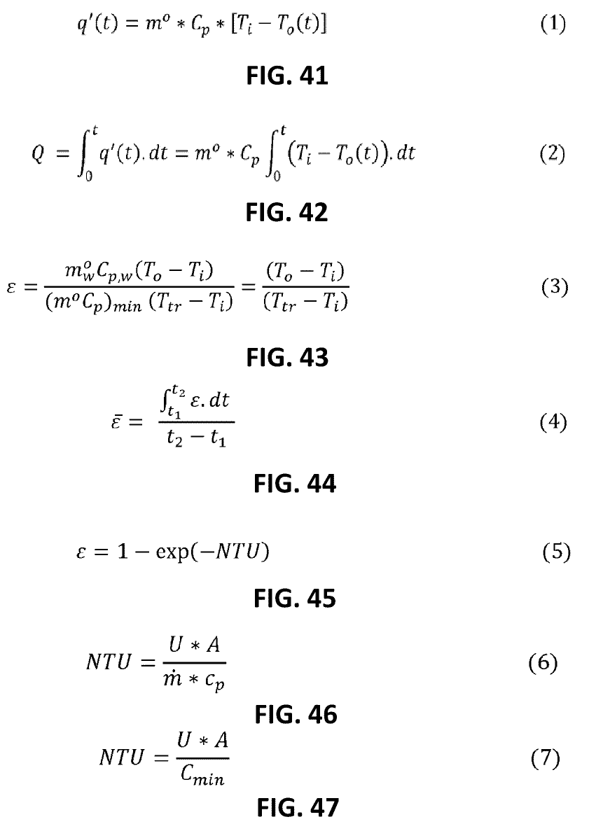

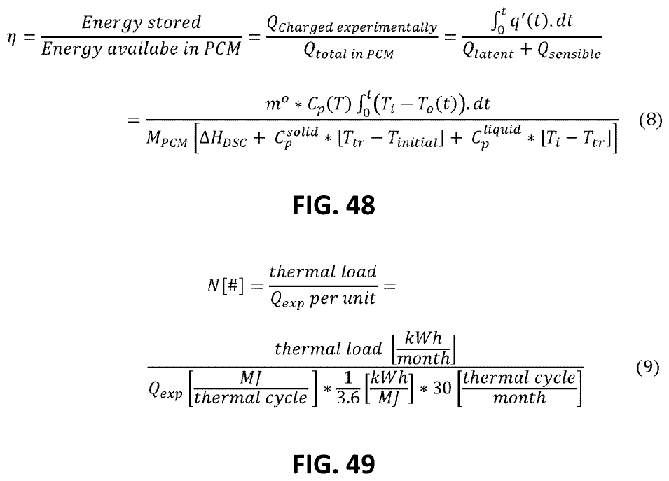

A summary of the thermal characteristics of the heat exchanger is presented in Table 10 of FIG. 40. The energy efficiency was calculated based on the thermodynamic equations given in Example 3. The physical significance of energy efficiency is to compare the total amount of available energy storage in the PCM to the amount of energy stored in the PCM. Higher mass flow rates and higher inlet temperatures showed higher efficiencies. Not intending to be bound by theory, this was attributed to the fact that higher inlet temperatures or flow rates achieve a smaller experimental time which reduces the time for heat leakage, thus increasing the efficiency as opposed to lower inlet flow rates and temperatures. The experimental times for various inlet conditions are given in Table 9. It is also suggested that for higher flow rates (higher UA values) there will be higher chances to utilize the PCMs next to the vessel walls at the peripheries, hence increasing the amount of PCM that can be utilized for energy storage and enhancing the stored energy to available energy ratio (efficiency, h). Higher inlet temperatures also include higher available sensible heat capacity in the vessel structure and aluminum plates; This amount however is relatively very small compared to the latent heat capacity of PCM.

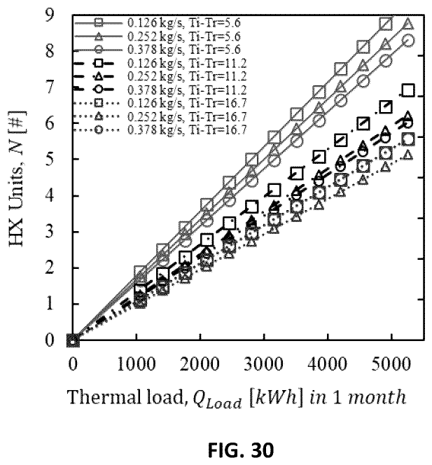

Table 10 presents the cumulative energy that can be stored where N is the number of heat exchanger units. Parametric analysis was conducted to predict the number of heat exchanger units as a function of the thermal load demand of the end user or heat load of the system. As given in equation 9 of FIG. 49, FIG. 30 presents the required number of heat exchanger units (N) required to supply a certain thermal load in kWh. Here, the necessary number of heat exchanger units was evaluated on the bases of monthly kWh requirements of the facility/thermal load using the thermal energy storage heat exchanger at a particular inlet conditions. For the monthly kWh requirements, it was assumed that each thermal energy storage unit will be charged and discharged once per day, for a total of 30 thermal cycles per month as given in equation 9. For A number of heat exchanger units installed in parallel, the thermal characteristics and operating conditions of each heat exchanger unit is supposed to remain the same and within the experimental conditions with a total mass flow rate for the entire system equals to N*m° and total energy storage of N*Qₑxₚ (kWh), where Qₑₓₚ is the experimental total energy storage capacity of one unit. The experimental conditions in the legend of FIG. 30 represents the inlet conditions of each heat exchanger unit, hence for A heat exchanger units the inlet temperature for each unit will be the same as those 71 values in the legend for a given 71-, whereas the mass flow rate of the entire system will be the product of N and the m° value in the legend to deliver the required thermal load (Qioad) value. Tₒ is a function of 71, 71- and m° per unit given in FIGS. 28A and 28B.

In conclusion, energy analysis was carried out for a PCM thermal energy storage unit in the form of parallel-plate heat exchanger in Examples 1-6. Compared to sensible heat systems, the latent heat storage of PCM in the system embodiments described herein provide larger storage capacity using smaller foot-print and constant supply temperature. Compared to ice storage latent heat systems, the embodiments of PCM systems described herein can deliver substantial cost-saving benefits in infrastructure, equipment and operation/maintenance costs. The PCM design storage temperature (18.3° C.) provides a unique opportunity for energy storage and load shifting in data centers, server rooms and pool-type nuclear reactors. An advantageous plate-plate spacing was found to be 1-inch in order to reduce the PCM self-shielding and yield a relatively lower exit water temperature. Effectiveness of more than 80% was achieved at an average power output of 4795 W. Finally, parallel arrangements can help in achieving lower mass flow rate per unit to achieve higher effectiveness when the total mass flow rate of the system is fixed, whereas series arrangement can help in increasing the heat exchange path length and achieve lower inlet temperature across the second unit and higher overall effectiveness when the inlet temperature is fixed. A combination of series and parallel arrangement can be used when the mass flow rate and inlet temperature are both fixed.

### IV. Embodiments

The following embodiments describe various alternative aspects of thermal energy storage systems and methods of using such systems. The following should not be construed as limiting, but, rather, a description of a variety of configurations and methods within the scope of the invention.

Embodiment 1. A thermal energy storage system comprising:
a container;
a heat exchanger disposed within the container; and
a phase change material disposed within the container,
wherein the heat exchanger comprises
an inlet pipe;
an outlet pipe; and
a number n of plates in fluid communication with the inlet pipe and the outlet pipe such that a fluid flowing from the inlet pipe and to the outlet pipe flows through the plates in between the inlet pipe and the outlet pipe;
wherein the phase change material is in thermal contact with the plates; and wherein the number n is at least 2.

Embodiment 2. The system of embodiment 1, wherein the container comprises exterior walls, interior walls, and a thermally insulating material disposed in between the exterior walls and the interior walls.

Embodiment 3. The system of embodiment 2, wherein the exterior walls and/or the interior walls are formed from a metal.

Embodiment 4. The system of embodiment 2, wherein the exterior walls and/or the interior walls are formed from plastic or a composite material.

Embodiment 5. The system of any of embodiments 2-4, wherein the thermally insulating material comprises a foam.

Embodiment 6. The system of any of the preceding embodiments, wherein the container is defined by a floor, side walls, and a cover.

Embodiment 7. The system of embodiment 6, wherein the floor, side walls, and/or cover of the container have an R-value of at least 4 square-foot*degree Fahrenheit*hour per British thermal unit per inch (ft²*° F.*h BTU*inch).

Embodiment 8. The system of embodiment 6 or embodiment 7, wherein a gasket is disposed between the cover and the side walls.

Embodiment 9. The system of any of embodiments 6-8, wherein the container comprises lugs on one or more exterior surfaces of the container.

Embodiment 10. The system of any of the preceding embodiments, wherein the container is not a standard shipping container.

Embodiment 11. The system of any of the preceding embodiments, wherein the inlet pipe of the heat exchanger passes through an exterior wall of the container, thereby providing fluid communication between the plates and an exterior of the container.

Embodiment 12. The system of any of the preceding embodiments, wherein the outlet pipe of the heat exchanger passes through an exterior wall of the container, thereby providing fluid communication between the plates and an exterior of the container.

Embodiment 13. The system of any of the preceding embodiments, wherein:
a first end of the inlet pipe of the heat exchanger passes through a first exterior wall of the container, thereby providing fluid communication between the plates and an exterior of the container; and
a second end of the inlet pipe, opposite the first end, passes through a second exterior wall of the container.

Embodiment 14. The system of embodiment 13, wherein:
a first end of the outlet pipe of the heat exchanger passes through the first exterior wall of the container; and
a second end of the outlet pipe of the heat exchanger passes through the second exterior wall of the container, thereby providing fluid communication between the plates and an exterior of the container.

Embodiment 15. The system of embodiment 14, wherein:
the second end of the inlet pipe is capped, such that fluid communication between the plates and an exterior of the container is prevented through the second end of the inlet pipe; and the first end of the outlet pipe is capped, such that fluid communication between the plates and an exterior of the container is prevented through the first end of the outlet pipe.

Embodiment 16. The system of embodiment 15, wherein the first exterior wall of the container and the second exterior wall of the container are in facing opposition to one another.

Embodiment 17. The system of any of the preceding embodiments, wherein the n plates are in fluid communication with the inlet pipe and the outlet pipe in parallel with one another.

Embodiment 18. The system of any of the preceding embodiments, wherein the n plates are not in fluid communication with the inlet pipe and the outlet pipe in series with one another.

Embodiment 19. The system of any of the preceding embodiments, wherein fluid flows through immediately adjacent plates in opposite directions.

Embodiment 20. The system of any of the preceding embodiments, wherein:
the inlet pipe, the outlet pipe, and the n plates define n separate flow paths between the first end of the inlet pipe and the second end of the outlet pipe; and
the n separate flow paths have the same or substantially the same length.

Embodiment 21. The system of any of the preceding embodiments, wherein:
the n plates have n flow velocities within the plates; and the n flow velocities have the same or substantially the same magnitude.

Embodiment 22. The system of any of the preceding embodiments, wherein:
the n plates are connected to the inlet pipe by n inlet fittings; and
the cross-sectional area of the inlet pipe is at least 0.8 times the total cross-sectional areas of the n inlet fittings combined.

Embodiment 23. The system of embodiment 22, wherein the cross-sectional area of the inlet pipe is greater than the total cross-sectional areas of the n inlet fittings combined.

Embodiment 24. The system of any of the preceding embodiments, wherein:
the n plates are connected to the outlet pipe by n outlet fittings; and the cross-sectional area of the outlet pipe is at least 0.8 times the total cross-sectional areas of the n outlet fittings combined.

Embodiment 25. The system of embodiment 24, wherein the cross-sectional area of the outlet pipe is greater than the total cross-sectional areas of the n outlet fittings combined.

Embodiment 26. The system of the any of the preceding embodiments, wherein the plates have two heat transfer surfaces in facing opposition to one another, the two heat transfer surfaces being joined to one another to form four edges.

Embodiment 27. The system of embodiment 26, wherein the average length and the average width of the two heat transfer surfaces are at least 50 times the average thickness of the four edges.

Embodiment 28. The system of embodiment 26 or embodiment 27, wherein the two heat transfer surfaces define one or more interior fluid flow channels.

Embodiment 29. The system of embodiment 28, wherein the one or more channels include includes a plurality of baffles.

Embodiment 30. The system of embodiment 28, wherein the one or more channels are defined by a plurality of joined regions of the two heat transfer surfaces.

Embodiment 31. The system of any of the preceding embodiments, wherein the plates are substantially parallel to one another.

Embodiment 32. The system of embodiment 31, wherein the plates are spaced apart from one another by an average distance (d) defined by one of Equations (1)-(3):

$${0.28}^{*} + 1.33 , for 0.01 < £ < 0.4 W / m \cdot K ; \qquad Equation ( 1 )$$

$$d = 023 k + 1.34 , for 0.41 < k < 1. W / m \cdot K ; and \qquad Equation ( 2 )$$

$$d = 0.12 £ + 1.44 , for > 1.01 W / m \cdot K , \qquad Equation ( 3 )$$

where d is the average plate-to-plate distance in inches and k is the thermal conductivity of the phase change material in contact with the plates.

Embodiment 33. The system of any of the preceding embodiments, wherein the plates are formed from metal.

Embodiment 34. The system of any of the preceding embodiments, wherein the phase change material is in direct physical contact with heat exchange surfaces of the plates.

Embodiment 35. The system of any of the preceding embodiments, wherein the heat exchanger is at least partially embedded in the phase change material.

Embodiment 36. The system of any of the preceding embodiments, wherein the phase change material has a phase transition temperature within one of the following ranges: 450-550° C.:
300-550° C.;
70-100° C.;
60-80° C.;
40-50° C.;
16-23° C.;
16-18° C.;
15-20° C.;
6-8° C.; and
−40 to −10° C.

Embodiment 37. The system of any of the preceding embodiments, wherein:
the container comprises a first chamber and a second chamber separated by a divider wall;
a first portion of the n plates is disposed in the first chamber;
a second portion of the n plates is disposed in the second chamber;
the inlet pipe comprises a first valve having an open position and a closed position, the valve dividing the inlet pipe into a first portion and a second portion;
the first valve is substantially aligned with the divider wall;
a first end of the inlet pipe passes through a first exterior wall of the container;
a second end of the inlet pipe, opposite the first end, passes through a second exterior wall of the container;
a first end of the outlet pipe passes through the first exterior wall of the container; a second end of the outlet pipe, opposite the first end, passes through the second exterior wall of the container;
the second end of the inlet pipe has an open configuration and a closed configuration; and
the second end of the outlet pipe has an open configuration and a closed configuration.

Embodiment 38. The system of embodiment 37, wherein:
the closed configuration of the second end of the inlet pipe is provided by a blind flange disposed over the second end of the inlet pipe; and/or
the closed configuration of the second end of the outlet pipe is provided by a blind flange disposed over the second end of the outlet pipe.

Embodiment 39. The system of embodiment 37, wherein:
the open configuration and the closed configuration of the second end of the inlet pipe are provided by a second valve disposed at the second end of the inlet pipe, the second valve having an open position and a closed position; and/or
the open configuration and the closed configuration of the second end of the outlet pipe are provided by a third valve disposed at the second end of the inlet pipe, the third valve having an open position and a closed position.

Embodiment 40. The system of embodiment 39, wherein:
the second valve is a flanged valve; and/or
the third valve is a flanged valve.

Embodiment 41. The system of any of embodiments 37-40, wherein:
the first end of the outlet pipe is sealed; and
when the first valve is in the open position, the second end of the inlet pipe is in the closed configuration, and the second end of the outlet pipe is in the open configuration, fluid flows simultaneously from both the first portion of the inlet pipe and also from the second portion of the inlet pipe, through both the first portion of the n plates and also through the second portion of the n plates, and then from the first portion of the n plates and also the second portion of the n plates into the outlet pipe.

Embodiment 42. The system of embodiment 41, wherein:
the first end of the outlet pipe is sealed; and
when the first valve is in the closed position, the second end of the inlet pipe is in the open configuration, and the second end of the outlet pipe is in the closed configuration, fluid flows from the first portion of the inlet pipe into the first portion of the n plates, then from the first portion of the n plates into the outlet pipe, then from the outlet pipe into the second portion of the n plates, and then from the second portion of the n plates into the second portion of the inlet pipe.

Embodiment 43. The system of any of embodiments 37-42, wherein:
Embodiment second phase change material is disposed in the second chamber.

Embodiment 44. The system of embodiment 43, wherein the first phase change material and the second phase change material are differing phase change materials having differing phase transition temperatures.

Embodiment 45. The system of embodiment 44, wherein the first phase change material has a higher phase transition temperature than the second phase change material.

Embodiment 46. The system of embodiment 44, wherein:
the first phase change material has a phase transition temperature of 15-25° C.; and the second phase change material has a phase transition temperature of 4-8° C.

Embodiment 47. A thermal energy management system, the system comprising:
a first thermal energy storage system comprising
a first container;
a first heat exchanger disposed within the first container; and
a first phase change material disposed within the first container,
wherein the first heat exchanger comprises
a first inlet pipe;
a first outlet pipe; and
a number n of first plates in fluid communication with the first inlet pipe and the first outlet pipe such that a fluid flowing from the first inlet pipe and to the first outlet pipe flows through the first plates in between the first inlet pipe and the first outlet pipe;
wherein the first phase change material is in thermal contact with the first plates; and wherein the number
n is at least 2; and
a second thermal energy storage system comprising
a second container;
a second heat exchanger disposed within the second container; and a second phase change material disposed within the second container, wherein the second heat exchanger comprises a second inlet pipe;
a second outlet pipe; and
a number m of second plates in fluid communication with the second inlet pipe and the second outlet pipe such that a fluid flowing from the second inlet pipe and to the second outlet pipe flows through the second plates in between the second inlet pipe and the second outlet pipe;
wherein the second phase change material is in thermal contact with the second plates; and
wherein the number m is at least 2;
wherein the first outlet pipe of the first energy storage system is connected to the second inlet pipe of the second energy storage system.

Embodiment 48. A method of storing and releasing thermal energy, the method comprising:
attaching a thermal energy storage system to an external source of an external fluid, wherein the thermal energy storage system comprises the system of any of embodiments 1-46.

Embodiment 49. The method of embodiment 48, wherein the external fluid is liquid water.

Embodiment 50. The method of embodiment 49, wherein the external source of the external fluid comprises an HVAC chiller or source of waste heat.

Embodiment 51. The method of any of embodiments 48-50 further comprising:
forcing a first portion of the external fluid through the heat exchanger of the thermal energy system.

Embodiment 52. The method of embodiment 51, wherein:
the first portion of the external fluid enters the heat exchanger at a first temperature (T1) and exits the heat exchanger at a second temperature (T2); and
T1 and T2 are different.

Embodiment 53. The method of embodiment 52, wherein T1 is higher than T2.

Embodiment 54. The method of embodiment 52, wherein T1 is lower than T2.

Embodiment 55. The method of any of embodiments 51-54, wherein:
the first portion of the external fluid participates in thermal energy exchange with the phase change material disposed in the container.

Embodiment 56. The method of embodiment 55, wherein the first portion of the external fluid transfers thermal energy to the phase change material, thereby lowering the temperature of the first portion of the external fluid.

Embodiment 57. The method of embodiment 56, wherein the phase change material stores at least a portion of the transferred thermal energy as latent heat.

Embodiment 58. The method of embodiment 57 further comprising:
forcing a second portion of the external fluid through the heat exchanger of the thermal energy system; transferring at least a portion of the stored latent heat from the phase change material to the second portion of the external fluid, thereby increasing the temperature of the second portion of the external fluid.

Embodiment 59. The method of embodiment 55, wherein the phase change material transfers thermal energy to the first portion of the external fluid, thereby increasing the temperature of the first portion of the external fluid.

Embodiment 60. The method of embodiment 59, wherein the phase change material transfers the thermal energy by discharging latent heat.

Embodiment 61. The method of embodiment 60 further comprising:
forcing a second portion of the external fluid through the heat exchanger of the thermal energy system; transferring thermal energy from the second portion of the external fluid to the phase change material, thereby decreasing the temperature of the second portion of the external fluid.

Various implementations and embodiments of systems, apparatus, and methods have been described in fulfillment of the various objectives of the present disclosure. It should be recognized that these implementations and embodiments are merely illustrative of the principles of the present disclosure. Numerous modifications and adaptations thereof will be readily apparent to those skilled in the art without departing from the spirit and scope of the present disclosure. For example, individual steps of methods described herein can be carried out in any manner and/or in any order not inconsistent with the objectives of the present disclosure, and various configurations or adaptations of apparatus described herein may be used.

1.-38. (canceled)

39. A thermal energy storage system comprising:
a container;
a heat exchanger disposed within the container; and
a phase change material disposed within the container;
wherein the heat exchanger comprises
an inlet pipe;
an outlet pipe; and
a plurality of plates in fluid communication with the inlet pipe and the outlet pipe such that a fluid flowing from the inlet pipe and to the outlet pipe flows through the plates in between the inlet pipe and the outlet pipe, the plates of the plurality of plates being spaced apart from one another by an average plate-to-plate distance that is no less than 1.43 inches and no greater than 1.57 inches;
wherein the phase change material is in thermal contact with the plurality of plates and has a thermal conductivity of between 0.41 W/(m*K) and 1.00 W/(m*K); and
wherein the numeric value of the average plate-to-plate distance when expressed in units of inches is equal to the sum of 1.34 and 23% of the numeric value of the thermal conductivity of the phase change material when expressed in units of W/(m*K).

40. The system of claim 39, wherein:
a first end of the inlet pipe of the heat exchanger passes through a first exterior wall of the container, thereby providing fluid communication between the plates and an exterior of the container; and a second end of the inlet pipe, opposite the first end, passes through a second exterior wall of the container; and
a first end of the outlet pipe of the heat exchanger passes through the first exterior wall of the container; and a second end of the outlet pipe of the heat exchanger passes through the second exterior wall of the container, thereby providing fluid communication between the plates and an exterior of the container.

41. The system of claim 40, wherein: the second end of the inlet pipe is capped, such that fluid communication between the plates and the exterior of the container is prevented through the second end of the inlet pipe; and the first end of the outlet pipe is capped, such that fluid communication between the plates and the exterior of the container is prevented through the first end of the outlet pipe.

42. The system of claim 41, wherein the first exterior wall of the container and the second exterior wall of the container are in facing opposition to one another.

43. The system of claim 39, wherein: the inlet pipe, the outlet pipe, and each of the plates defines a separate flow path between the first end of the inlet pipe and the second end of the outlet pipe; and the separate flow paths have the same or substantially the same length.

44. The system of claim 39, wherein: each of the plates has a flow velocity therethrough; and the flow velocities of the plates have the same or substantially the same magnitude.

45. The system of claim 39, wherein: each of the plates are connected to the inlet pipe by an inlet fitting; and the cross-sectional area of the inlet pipe is at least 0.8 times the total cross-sectional areas of the inlet fittings combined.

46. The system of claim 45, wherein the cross-sectional area of the inlet pipe is greater than the total cross-sectional areas of the inlet fittings combined.

47. The system of claim 39, wherein: each of the plates is connected to the outlet pipe by an outlet fitting; and the cross-sectional area of the outlet pipe is at least 0.8 times the total cross-sectional areas of the outlet fittings combined.

48. The system of claim 47, wherein the cross-sectional area of the outlet pipe is greater than the total cross-sectional areas of the outlet fittings combined.

49. The system of claim 39, wherein: the inlet pipe of the heat exchanger passes through an exterior wall of the container, thereby providing fluid communication between the plates and an exterior of the container; and the outlet pipe of the heat exchanger passes through an exterior wall of the container, thereby providing fluid communication between the plates and an exterior of the container.

50. The system of claim 39, wherein the plates have two heat transfer surfaces facing in opposite directions, the two heat transfer surfaces being joined to one another to form four edges.

51. The system of claim 50, wherein the average length and the average width of the two heat transfer surfaces are at least 50 times the average thickness of the four edges.

52. The system of claim 50, wherein the two heat transfer surfaces define one or more interior fluid flow channels.

53. The system of claim 52, wherein the one or more channels include a plurality of baffles.

54. The system of claim 39, wherein:
the container comprises a first chamber and a second chamber separated by a divider wall;
a first portion of the plurality of plates is disposed in the first chamber;
a second portion of the plurality of plates is disposed in the second chamber;
the inlet pipe comprises a first valve having an open position and a closed position, the first valve dividing the inlet pipe into a first portion and a second portion;
the first valve is substantially aligned with the divider wall;
a first end of the inlet pipe passes through a first exterior wall of the container;
a second end of the inlet pipe, opposite the first end, passes through a second exterior wall of the container;
a first end of the outlet pipe passes through the first exterior wall of the container;
a second end of the outlet pipe, opposite the first end, passes through the second exterior wall of the container;
the second end of the inlet pipe has an open configuration and a closed configuration; and
the second end of the outlet pipe has an open configuration and a closed configuration.

55. A thermal energy storage system comprising:
a container;
a heat exchanger disposed within the container; and
a phase change material disposed within the container;
wherein the heat exchanger comprises
an inlet pipe;
an outlet pipe; and
a plurality of plates in fluid communication with the inlet pipe and the outlet pipe such that a fluid flowing from the inlet pipe and to the outlet pipe flows through the plates in between the inlet pipe and the outlet pipe, the plates of the plurality of plates being spaced apart from one another by an average plate-to-plate distance that is no less than 1.33 inches and no greater than 1.44 inches;
wherein the phase change material is in thermal contact with the plurality of plates and has a thermal conductivity of between 0.01 W/(m*K) and 0.40 W/(m*K); and
wherein the numeric value of the average plate-to-plate distance when expressed in units of inches is equal to the sum of 1.33 and 28% of the numeric value of the thermal conductivity of the phase change material when expressed in units of W/(m*K).

56. The system of claim 55, wherein:
the container comprises a first chamber and a second chamber separated by a divider wall;
a first portion of the plurality of plates is disposed in the first chamber;
a second portion of the plurality of plates is disposed in the second chamber;
the inlet pipe comprises a first valve having an open position and a closed position, the first valve dividing the inlet pipe into a first portion and a second portion;
the first valve is substantially aligned with the divider wall;
a first end of the inlet pipe passes through a first exterior wall of the container;
a second end of the inlet pipe, opposite the first end, passes through a second exterior wall of the container;
a first end of the outlet pipe passes through the first exterior wall of the container;
a second end of the outlet pipe, opposite the first end, passes through the second exterior wall of the container;
the second end of the inlet pipe has an open configuration and a closed configuration; and
the second end of the outlet pipe has an open configuration and a closed configuration.

57. A thermal energy storage system comprising:
a container;
a heat exchanger disposed within the container; and
a phase change material disposed within the container;
wherein the heat exchanger comprises
an inlet pipe;
an outlet pipe; and
a plurality of plates in fluid communication with the inlet pipe and the outlet pipe such that a fluid flowing from the inlet pipe and to the outlet pipe flows through the plates in between the inlet pipe and the outlet pipe, the plates of the plurality of plates being spaced apart from one another by an average plate-to-plate distance that is no less than 1.56 inches;
wherein the phase change material is in thermal contact with the plurality of plates and has a thermal conductivity no less than 1.01 W/(m*K); and
wherein numeric value of the average plate-to-plate distance when expressed in units of inches is equal to the sum of 1.44 and 12% of the numeric value of the thermal conductivity of the phase change material when expressed in units of W/(m*K).

58. The system of claim 57, wherein:
the container comprises a first chamber and a second chamber separated by a divider wall;
a first portion of the plurality of plates is disposed in the first chamber;
a second portion of the plurality of plates is disposed in the second chamber;
the inlet pipe comprises a first valve having an open position and a closed position, the first valve dividing the inlet pipe into a first portion and a second portion;
the first valve is substantially aligned with the divider wall;
a first end of the inlet pipe passes through a first exterior wall of the container;
a second end of the inlet pipe, opposite the first end, passes through a second exterior wall of the container;
a first end of the outlet pipe passes through the first exterior wall of the container;
a second end of the outlet pipe, opposite the first end, passes through the second exterior wall of the container;
the second end of the inlet pipe has an open configuration and a closed configuration; and
the second end of the outlet pipe has an open configuration and a closed configuration.
